(19) United States
(12) Patent Application Publication
(10) Pub. No.: US 2008/0065513 A1
(43) Pub. Date: Mar. 13, 2008

(54) METHOD AND APPARATUS FOR SPONSORING A CONSIGNABLE ITEM IN AN ON-LINE CHARITABLE AUCTION OR FUND RAISING EVENT

(75) Inventors: Gregory C. McHale, Melrose, MA (US); Paul Sheppard, Jamaica Plain, MA (US); Todd K. Rodgers, West Newbury, MA (US)

Correspondence Address: RISSMAN JOBSE HENDRICKS & OLIVERIO, LLP, 100 Cambridge Street, Suite 2101, BOSTON, MA, 02114, US

(73) Assignee: cMarket, Inc., Cambridge, MA (US)

(21) Appl. No.: 11/737,858

(22) Filed: Apr. 20, 2007

Related U.S. Application Data
(63) Continuation-in-part of application No. 11/469,114, filed on Aug. 31, 2006.

(51) Int. Cl. G06F 17/30

(52) U.S. Cl. 705/27

(57) ABSTRACT

Disclosed are methods, systems, and program code that enable a nonprofit organization to manage its fundraising activities online, including online hosting of auctions, and auction services such as maintaining donor/bidder registries, bid tracking, processing credit cards, and auction closeout activities. A consignment database enables organizations to build catalogs using items made available from a consignment catalog for inclusion in an auction or raffle. Also disclosed is a sponsor engine that enables registered donors to contribute all or a portion of the cost of a consignment item. The sponsor engine uses the cost of the item and the number of desirable donors to suggest a plurality of sponsorship levels, for example $50, $100, $150. The sponsor engine computes and compares the total of received sponsorship dollars with the cost of the consignment item, and either closes sponsorships once the price has been reached or instantiate a new similar consignment item. Optionally, the level of a sponsor donation defines the visibility of a sponsorship attribution associated with the item.

### RELATED APPLICATIONS

This application is a continuation-in-part of and claims priority to commonly assigned U.S. patent application Ser. No. 11/469,114 entitled METHOD AND APPARATUS FOR CREATING A CATALOG FOR AN ON-LINE CHARITABLE AUCTION OR FUND RAISING EVENT FROM A VIRTUAL CONSIGNMENT DATABASE IN ACCORDANCE WITH AN ORGANIZATION PROFILE filed Aug. 31, 2006 by inventors Gregory C. McHale, Paul Sheppard and Todd K. Rodgers, attorney docket number C0017/7009, the subject matter of which is incorporated herein by reference for all purposes.

### FIELD OF THE INVENTION

This invention relates to on line charitable fund raising events, such as on-line auctions, and the system and techniques for facilitating the creation and execution of such activities.

### BACKGROUND OF THE INVENTION

Publicly accessible wide area networks (WANs), such as the Internet and the World Wide Web, have transformed the manner in which transactions occur. Such transactions include not only business transactions but other activities, such as on-line auctions and charitable fund solicitation and giving. On-line auctions, such as those facilitated by eBay, provide venues for buyers and sellers to transact business in a complex, global virtual marketplace. Charities and not for profit organizations have also tapped the vast market potential of the Internet to reach a wider audience of potential donors. Specifically, web sites such as ePhilanthropyFoundation.com exist to foster the ethical and efficient use of the Internet for philanthropic purposes. Indeed, many charitable organizations allow on line users to donate money directly through a web site to the organization. However, many of the same charitable organizations continue to rely on traditional fundraising events such as telethons and walkathons to raise money at the local community level, without any significant assistance or interaction with on line tools or the local online community. In addition, many fundraising events provide limited opportunities for participation other than through purchasing of item or participation in an event such as a walkathon.

Accordingly, the need exist for charitable organizations and not for profit entities to increase their presence in the global and local on-line marketplace and for techniques to enable fundraising events to combine and integrate various aspects of more traditional events.

A further need exists for the ability to rapidly facilitate the creation of an on-line auction, including the review and selection of items for the on-line auction.

A further need exists for the ability for would be donors to help sponsor or underwrite the actual costs of the charitable event without having to actively purchase an item.

### SUMMARY OF THE INVENTION

The present invention discloses methods, systems, and program code that enable a nonprofit organization to manage its fundraising activities online. The inventive system provides online hosting of fundraising auctions, and auction services such as maintaining donor/bidder registries, bid tracking, processing credit cards, and auction closeout activities. Also disclosed are a plurality of on-line, web-based tools, including tools for: 1) building a customized homepage reflecting the look and feel of the nonprofit organization; 2) building a customized catalog that allows for easy addition of items and pictures; and 3) enhanced email messaging that lets a nonprofit organization reach its constituents. The subject invention provides the tools and facilities for a nonprofit or charitable entity to create either a live or virtual auction event, compile lists of potential donor/bidder participants, create a catalog from donated items, combine individual donated items into aggregate item offerings, and facilitate on line viewing and bidding of the published catalog items in a manner that is efficient and capable of reaching the vast potential of the virtual online community for a particular cause.

According to the invention, a consignment database enables organizations to build catalogs using items made available from a consignment catalog for inclusion in an auction or raffle. An organization profile is used to determine which items can be selected from the consignment catalog, reserving high value items for high profile events. A consignment registration function/module enables tracking of virtual consigned merchandise, including a inventory control function that monitors which items are referenced by which charitable organizations, auctions and catalogs. A selection filter associated with the consignment database allows a charitable organization access to a set of items for which the organization qualifies according to their profile. A multi-faceted organization profile provides the input necessary to filter appropriate items within the consignment database. The profile may be based on the organization's email list size, target revenue, catalog size, catalog value, etc.

A set of user interfaces enable a client organization or vendor to manage the process of ordering, managing, selling, and reporting of items selected from the database, creating an online market or store that enables organizations to view and select available items based upon selection criteria from the organization and upon availability criteria from the vendor. In addition to consignment, items may be free or available for purchase at time of selection.

In one embodiment, the cost of a consignable item may be defrayed through contributions from sponsors or bidders who are interested in contributing to the charitable or nonprofit client without having to actually bid on an auction item. A sponsor engine associated with the consignment database enables registered donors or bidders to sponsor or contribute all or a portion of the cost of a consignment item either prior to or during the auctioning of the item. The sponsor engine uses the cost of the item and the number of desirable donors to suggest a plurality of sponsorship announcements, for example $50, $100, $150. Items that are available for sponsorship are displayed in the virtual catalog all with all other items and provide a selectable graphic which enables sponsorship. The sponsor engine computes and compares the total of received sponsorship dollars with the cost of the consignment item, and either closes sponsorships once the price has been reached or instantiate a new similar consignment item. Optionally, the level of a sponsor donation defines the visibility of a sponsorship attribution associated with the item.

According to one aspect of the invention, in a computer program product for use with a computer system operatively connectable to a network and capable of capable of maintaining and displaying a virtual display of items associated with an auction, the computer program product comprising a computer readable medium having embodied therein program code comprising: (A) program code for receiving selection indicia identifying one of the items associated with the auction, said item having a cost associated therewith; (B) program code for calculating an index having a value less that the cost associated with the item; and (C) program code, responsive to the index value, for identifying a first sponsorship level associated with the item; and (D) program code for presenting the first sponsorship level.

According to a second aspects of the invention, a computer program product for use with a computer system operatively connectable to a network and capable of capable of maintaining and displaying a virtual catalog of items associated with an auction, comprises a computer readable medium having embodied therein program code comprising: (A) program code for maintaining an online accessible user-interface to a memory associated with data describing a plurality of consignable items; (B) program code for defining at least one sponsorship level associated with a cost value of a consignable item; (C) program code for receiving sponsor information identifying a sponsor and a donation value applicable to said cost of the consignable item; (D) program code for determining if the value of the donation at least meets the sponsorship level; and (E) program code for enabling display of one of the plurality of consignable items in conjunction with a link to a user interface for providing sponsor information.

According to a third aspect of the invention, a computer system operatively connectable to a network and capable of capable of maintaining data describing a plurality of items associated with an auction, a method comprising: (A) displaying a plurality of consignable items associated with an auction; (B) associating the plurality of consignable items with at least one of a plurality of sponsorship levels, each level having associated therewith a range of acceptable donation amounts; and (C) providing a link to a user interface for providing one of sponsor information.

According to a fourth aspect of the invention, in a computer system operatively connectable to a network and capable of capable of maintaining and displaying a virtual catalog of items associated with an auction, an apparatus comprises: (A) program logic for receiving selection indicia identifying one of the items associated with the auction, said item having a cost value associated therewith; (B) program logic for calculating an index having a value less that the cost value associated with the item; and (C) program logic, responsive to the index value, for identifying a first sponsorship level associated with the item; and (D) program logic for presenting the first sponsorship level.

### BRIEF DESCRIPTION OF THE DRAWINGS

The above and further advantages of the invention may be better understood by referring to the following description in conjunction with the accompanying drawings in which:

FIG. 1 is a block diagram of a computer system suitable for use with an embodiment of the present invention;

FIG. 2 is a conceptual block diagram of the elements of the inventive system in a network environment;

FIG. 3 is a conceptual block diagram of the elements of the inventive system in accordance with an embodiment of the present invention;

FIG. 4 illustrates conceptually the logical organization of the various functional modules of the inventive system in accordance with an embodiment of the present invention;

FIG. 5 is a table illustrating an automatically generated timeline and activity list associated with an auction event in accordance with an embodiment of present invention;

FIGS. 6A-C are screen captures of the graphic user interface of the inventive system in accordance with an embodiment of the present invention;

FIGS. 7A-B are a flow diagram of the processes utilized in the inventive system for scheduling events in accordance with an embodiment of present invention;

FIGS. 8A-E are screen captures of the graphic user interface of the inventive system in accordance with an embodiment of the present invention;

FIGS. 9A-C are screen captures of the graphic user interface of the inventive system in accordance with t an embodiment of the present invention;

FIG. 10 is a flow diagram of the processes utilized in the inventive system for editing properties of donated items in accordance with an embodiment of present invention;

FIG. 11 is a diagram of the processes utilized in the inventive system for combining plural items into a composite auction item in accordance with an embodiment of present invention;

FIGS. 12-16 are screen captures of the graphic user interface of the inventive system in accordance with an embodiment of the present invention;

FIGS. 17-21 are conceptual diagrams of the object records in memory and the interrelations therebetween in accordance with an embodiment of present invention;

FIGS. 22-23 are screen captures of a user interface for editing and combining auction items in accordance with an embodiment of present invention;

FIG. 24 is a conceptual diagram of a donor page in accordance with present invention;

FIG. 25 is a conceptual diagram of the object records in memory and the interrelations therebetween;

FIG. 26 illustrates conceptually the logical organization of the various functional modules of a system in accordance with an embodiment of an embodiment of present invention;

FIG. 27 is a flow diagram of the processes utilized in the inventive system for building a catalog from third party items in accordance with an embodiment of present invention;

FIGS. 28-31 are screen captures of a user interface for selecting auction items from predetermined inventories of available items in accordance with an embodiment of present invention;

FIGS. 32A-B form a flow diagram of the processes utilized for assigning a sponsorship levels and building a catalog from third party items in accordance with present invention;

FIGS. 32A-B form a flow diagram of the processes utilized for assigning a sponsorship levels and building a catalog from third party items in accordance with present invention; and

FIGS. 34-37 are screen captures of a user interface for sponsoring selected auction in accordance with an embodiment of the present invention.

### DETAILED DESCRIPTION

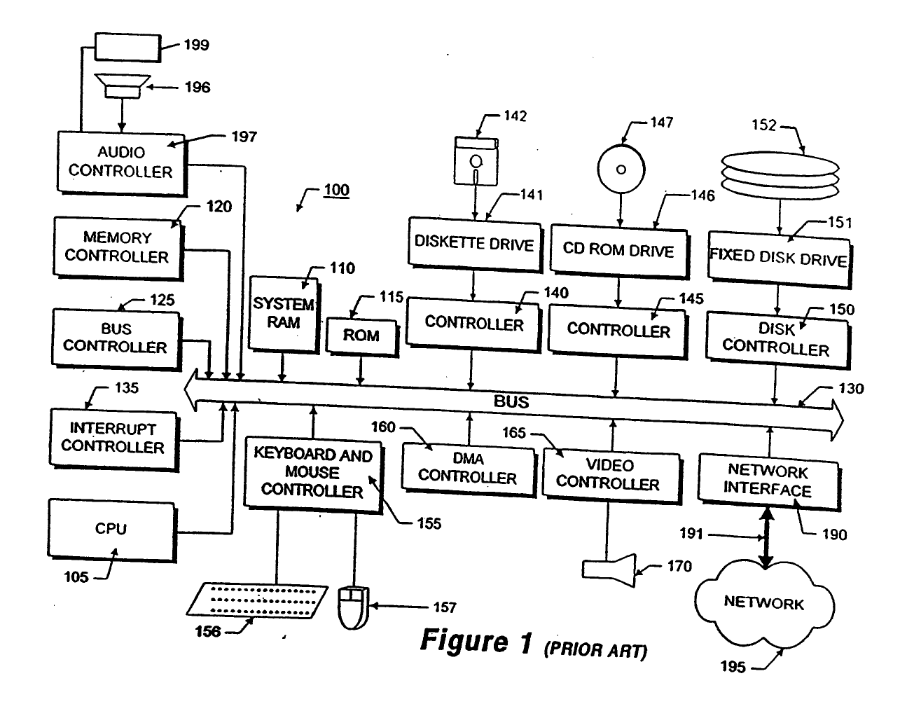

FIG. 1 illustrates the system architecture for a computer system 100, such as a Dell Dimension 8200, commercially available from Dell Computer, Dallas Tex., on which the invention can be implemented. The exemplary computer system of FIG. 1 is for descriptive purposes only. Although the description below may refer to terms commonly used in describing particular computer systems, the description and concepts equally apply to other systems, including systems having architectures dissimilar to FIG. 1.

The computer system 100 includes a central processing unit (CPU) 105, which may include a conventional microprocessor, a random access memory (RAM) 110 for temporary storage of information, and a read only memory (ROM) 115 for permanent storage of information. A memory controller 120 is provided for controlling system RAM 110. A bus controller 125 is provided for controlling bus 130, and an interrupt controller 135 is used for receiving and processing various interrupt signals from the other system components. Mass storage may be provided by diskette 142, CD ROM 147 or hard drive 152. Data and software may be exchanged with computer system 100 via removable media such as diskette 142 and CD ROM 147. Diskette 142 is insertable into diskette drive 141 which is, in turn, connected to bus 130 by a controller 140. Similarly, CD ROM 147 is insertable into CD ROM drive 146 which is connected to bus 130 by controller 145. Hard disk 152 is part of a fixed disk drive 151 which is connected to bus 130 by controller 150.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices such as a pen and/or tablet and a microphone for voice input may be connected to computer system 100 through bus 130 and an appropriate controller/software. DMA controller 160 is provided for performing direct memory access to system RAM 110. A visual display is generated by video controller 165 which controls video display 170. In the illustrative embodiment, the user interface of a computer system may comprise a video display and any accompanying graphic use interface presented thereon by an application or the operating system, in addition to or in combination with any keyboard, pointing device, joystick, voice recognition system, speakers, microphone or any other mechanism through which the user may interact with the computer system.

Computer system 100 also includes a communications adapter 190 which allows the system to be interconnected to a local area network (LAN) or a wide area network (WAN), schematically illustrated by bus 191 and network 195.

Computer system 100 is generally controlled and coordinated by operating system software, such as the WINDOWS NT, WINDOWS XP or WINDOWS 2000 operating system, available from Microsoft Corporation, Redmond Wash. The operating system controls allocation of system resources and performs tasks such as process scheduling, memory management, and networking and I/O services, among other things. In particular, an operating system resident in system memory and running on CPU 105 coordinates the operation of the other elements of computer system 100. The present invention may be implemented with any number of commercially available operating systems including OS/2, AIX, UNIX and LINUX, DOS, etc. One or more applications 220 may execute under control of the operating system. If operating system 210 is a true multitasking operating system, multiple applications may execute simultaneously.

In the illustrative embodiment, the present invention may be implemented using object-oriented technology and an operating system which supports execution of object-oriented programs. For example, the inventive code module may be implemented using the Java programming environment from Sun Microsystems, Redwood, Calif.

The Java programming language is rapidly emerging as the preferred OOP language for Internet and cross platform use because Java programs consist of bytecodes, which are architecture and operating system independent and can be sent over the Internet and other networks. The bytecode is actually executed on a particular platform by means of a “virtual machine” (VM) which allows a Java program to be run on any platform, regardless of whether the Java program was developed on, or for, the particular platform which attempts to run the Java program. Java bytecodes which arrive at the executing machine are interpreted and executed by the embedded VM.

A complete Java program is known as an application, while a segment of Java code, which does not amount to a full application, but is reusable, is referred to as an “applet”. Java also includes a component model where a component is a self-contained object with a predefined interface. A component within Java is referred to as a “bean,” and includes such a defined interface. Java beans are used within applets and applications and a programmer need not know the internal structure of the Java bean to use it, he need only know the interface. Since Java is well-suited to operation over networks, the following description of the illustrative embodiment is directed toward the Java programming language. However, it will be obvious to those skilled in the art that the invention could be implemented for other OOP languages as well, e.g. C++.

As will be understood by those skilled in the art, Object-Oriented Programming (OOP) techniques involve the definition, creation, use and destruction of “objects”. These objects are software entities comprising data elements, or attributes, and methods, or functions, which manipulate the data elements. The attributes and related methods are treated by the software as an entity and can be created, used and deleted as if they were a single item. Together, the attributes and methods enable objects to model virtually any real-world entity in terms of its characteristics, which can be represented by the data elements, and its behavior, which can be represented by its data manipulation functions. In this way, objects can model concrete things like people and computers, and they can also model abstract concepts like numbers or geometrical designs.

Objects are defined by creating “classes” which are not objects themselves, but which act as templates that instruct the compiler how to construct the actual object. A class may, for example, specify the number and type of data variables and the steps involved in the methods which manipulate the data. When an object-oriented program is compiled, the class code is compiled into the program, but no objects exist. Therefore, none of the variables or data structures in the compiled program exist or have any memory allotted to them. An object is actually created by the program at runtime by means of a special function called a constructor which uses the corresponding class definition and additional information, such as arguments provided during object creation, to construct the object. Likewise objects are destroyed by a special function called a destructor. Objects may be used by using their data and invoking their functions. When an object is created at runtime memory is allotted and data structures are created.

Network Environment

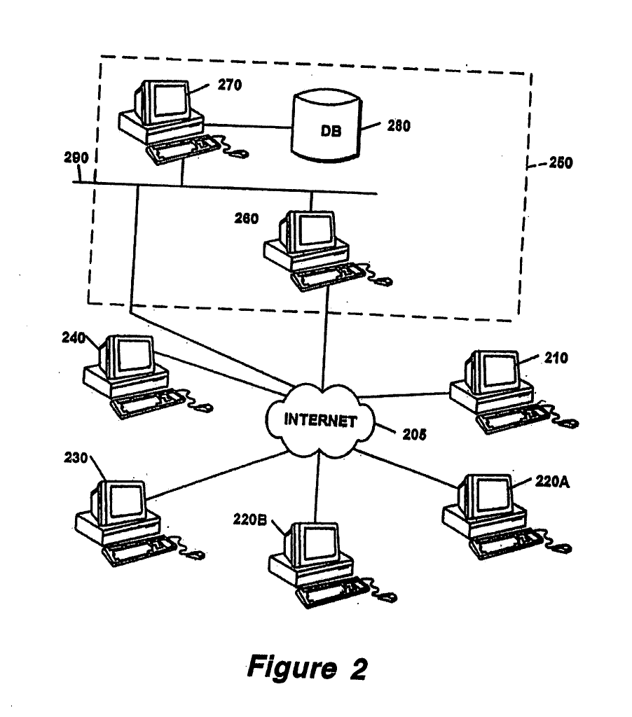

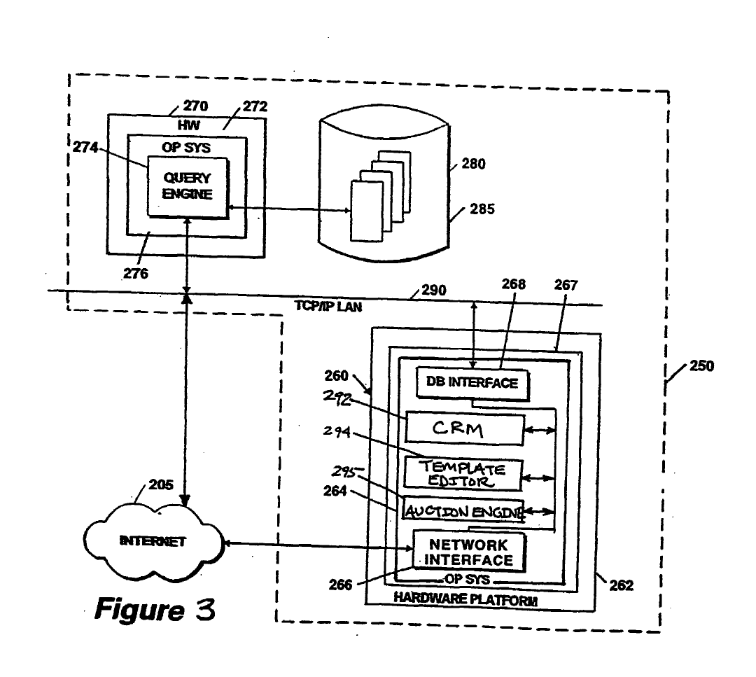

Referring to FIG. 2, illustrates conceptually a network topology in which the auction system 250 of present invention may be implemented. Specifically, a publicly accessible, wide area network topology, such as the Internet, labeled 205, operatively couples a plurality of systems, and their respective executing process, including bidder/donor processes 220A-B, sponsor web server 230 and credit server 210, charitable client system 240, and system 250, highlighted in phantom, which further comprises auction web server 260, database server 270 and database 280 interconnected over a private network 290, as illustrated. All of the system illustrated in FIG. 2 may execute on hardware platforms which may be similar to that described with reference to FIG. 1.

In the illustrative embodiment, auction web server 260 performs the functions of a traditional web server enabling access to one or more web pages by bidder/donor processes 220A-B connected to Internet 205. One or more of the pages accessible on auction web server 260 may contain address information in the form of a Hypertext Markup Language (HTML) tag which may be downloaded over the Internet 205 to a browser process executing on any of the system 210-240.

In the illustrative embodiment, sponsor web server 230 also may perform the functions of a traditional web server enabling access to one or more web pages by bidder/donor processes 220A-B connected to Internet 205. One or more of the pages accessible on sponsor web server 230 may contain address information in the form of a Hypertext Markup Language (HTML) tag which may be downloaded over the Internet 205 to a browser process executing on any of the other system in the network.

User/bidder systems 220A-B may be implemented using a computer architecture similar to that illustrated with reference to FIG. 1. The hardware platform may include a network interface, such as a Ethernet LAN card or other LAN-based TCP/IP network connector, for interfacing system 220 with the Internet, and executes a computer operating system, such as Windows NT 4.0, available from Microsoft Corporation, Redmond, Wash. Execution under the control of operating system is web browser application which may be implemented with any number of commercially available Java enabled web browser that provide standard JavaScript support, such as NetScape Navigator version 4.5 and above, commercially available from America On-line, Reston, Va.; Microsoft Internet Explorer version 4.0, commercially available from Microsoft Corporation, Redmond, Wash. Alternatively, the user system browser may execute in conjunction with the collaborative communication program, such as Sametime, commercially available from International Business Machines Corp., or Groove, commercially available from Groove Networks Inc., Beverley, Mass., or other collaborative communication programs that are Java enabled and have standard JavaScript support.

Credit server 210 may be implemented using a computer architecture similar to that illustrated with reference to FIG. 1. Credit server 210 is typically part of a publicly accessible Internet maintained by a bank or other electronics funds transfer facility or institution, such as those run by MasterCard or Visa and contains the appropriate server applications and database software for clearing in conducting electronic transactions in that are understood by those recently skilled in the arts.

System Organization

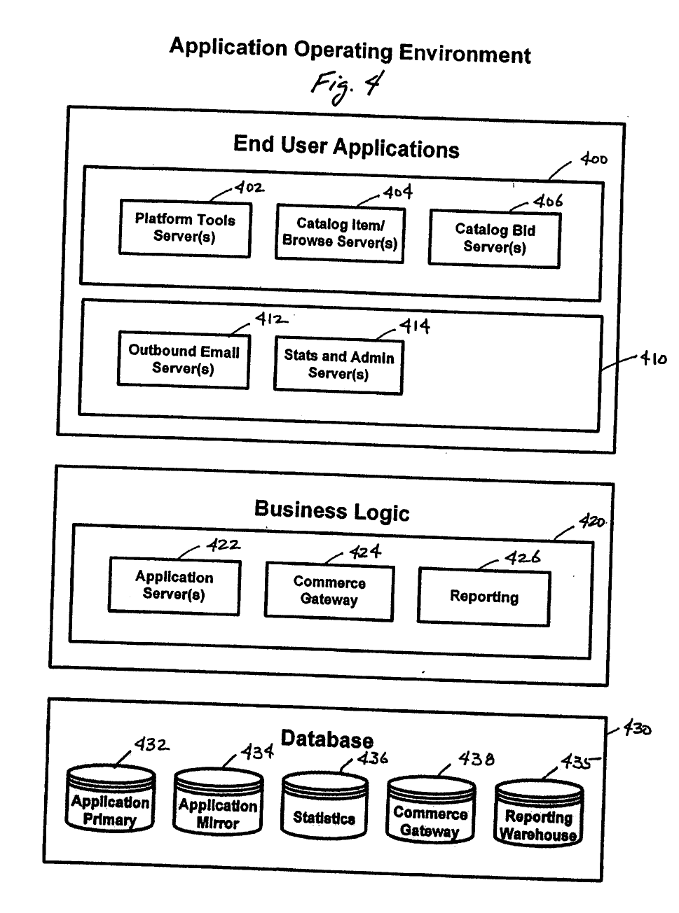

Referring to FIG. 3, a conceptual block diagram of the auction system 250 in accordance with the present invention is illustrated. The system 250 comprises a auction web server 260, a database server 270 and database(s) 280, and an optional electronic mail server 288 operatively coupled, in the illustrative embodiment, via a private network 292, e.g., a packet-switched network, such as a Local Area Network executing the TCP/IP protocol.

Private network 290 may couple auction web server 260 to both an optional electronic mail server (not shown) and to a firewall server (not shown). In the illustrative embodiment of the present invention, electronic mail server 288 may be implemented as a server executing an application program in accordance with the Post Office Protocol version 3.0 (POP3), such server capable of receiving and sending electronic mail in a manner understood by those skilled in the arts. In an alternative embodiment, the optional electronic mail server and web server 260 may be implemented with applications which execute on the same computer system. The firewall server may be implemented as a server or network appliance executing any of a number of commercially available network security applications which prevent unauthorized access to private networks in a manner understood by those skilled in the arts. The firewall server is typically connected to Internet 205, via a T1 line, or other connection such as a frame relay connection.

Web Server

Web server 260 may be implemented using a hardware platform similar to that illustrated with reference to FIG. 1. Executing under the control of an operating system are one or more functional code modules necessary for auction web server 260 to perform its appropriate functions. Specifically, web server 260 executes Constituency Relation Management (CRM) module 292, template editor module 294, and auction services engine 295, as illustrated. These functional delineations performed by web server 260 may be implemented with a plurality of sub components as illustrated in FIG. 4, and as described herein.

Referring to FIG. 3, web server 260 presents web pages to the network user and controls the flow of information to/from database server 270. In the illustrative embodiment, the functions performed by web server 260, and constituency Relation Management (CRM) module 292, template editor module 294, and auction services engine 295, may be implemented either with object-oriented programming techniques using the appropriate class definitions and objects for values within the database, or, alternatively, using a non-object oriented language such as the C++ programming language.

Web server 260 retains in memory one or more “pages” which collectively may comprise a web site used to visually present the information on the pages. One or more of the pages accessible on web server 260 may contain address information in the form of a Hypertext Markup Language (HTML) tag which may be downloaded over the Internet 205 to a browser process executing on any of the other computer systems connected to the network. Such HTML tag may include the IP address or E-mail address associated with the web site.

Upon connection to web server 260, either directly or through a hyperlink from the website of a vendor client, a network user is presented with a graphic user interface. The graphic user interface includes a number of web pages which are resident on web server 260 and through which the network user may navigate. The web pages include a number of menus and dialog boxes which allow the network user to interact with the web server 260. The sample web pages illustrated herein include various highlight options and dialog boxes through which a network user may interact with web server 260.

Web server 260 functions to render pages to a network user connected to the web server 260 and to pass data received from a network user to database through the appropriate Application Program Interfaces (APIs). In the illustrative embodiment, the web server 260 may utilize a plurality of Visual Basic, Java script files and/or Java applets to create active web pages. Web server 260 may include a database interface (not shown) which functions as the interface between web server 260 and database server 270. Such database interface may be implemented via ODBC, Remote Procedure Call libraries or other similar technologies which enables the interface to make remotely access the database server 270 and to service calls received from database server 270.

Data Base Architecture

In the illustrative embodiment, database server 270 and database 280 may comprise a hardware platform and an operating system capable of executing one of a number of commercially available database products. In the illustrative embodiment, hardware platform may be implemented with a computer system similar to that described with reference to FIG. 1. The operating system may be implemented with the Windows NT 4.0 product from Microsoft. The database product may be implemented with Microsoft SQL Server Version 7.0, also commercially available from Microsoft Corporation. The structure of information, including the data fields, records, tables which comprise database 280 are described hereinafter and may also be designed using Microsoft SQL Server Version 7.0.

Query engine 274 receives information from web server 260 in the form of a query and supplies the query to database 280. Database server 270 and database 280 may communicate using SQL standard database query language. The SQL standard is published by the American National Standards Institute (ANSI). The database query engine which is integrated into database server filters the queries received from web server 260, such filters useful in focusing or customizing the scope of a database query. The information retrieved from database 280 may be forwarded by database server 270 to web server 260 using any number of know techniques such as remote procedural call libraries, as that previously described.

Application Operating Environment

Referring to FIG. 4, the subcomponents that perform the necessary algorithmic processes of the inventive system are logically divided in application operating environment that includes end-user applications 400, specialty front end applications 410, business logic applications 420, and database applications 430. The end-user applications 400 comprise a series of server applications that provide functionality to bidder/donor processes and charitable client processes (auction committee) and comprise platform tools server(s) 402, catalog/item browser server(s) 404, and catalog bid server(s) 406. The specialty front end applications 410 comprise a series of server applications that provide specific functionality for system administration and include outbound electronic mail server(s) 412 and statistics and system administration server(s) 414. The business logic applications 420 comprise a series of server applications that provide functionality for operating in a network environment including application server(s) 422, commerce gateway application server(s) 424, and reporting server(s) 426. The database applications 430 comprise a primary catalog database 432, a mirror catalog database 434, and electronic mail stack database 436, a gateway transactions database 438, and a reporting database 435.

In the illustrative embodiment, end-user applications 400, specialty front end applications 410, business logic applications 420, may execute on auction web server 260, while database applications 430 may execute on database server 270 in conjunction with database 280, as illustrated in FIG. 3. Alternatively, for more sophisticated systems, any of the end-user applications 400, specialty front end applications 410, business logic applications 420, and database applications 430 may execute or their own separate system, accessible through either public and/or private networks. In this matter, a particular system may have a dedicated application function. In addition, multiple systems may perform the same function, for example there may be multiple servers each performing catalog bid receipt and recording functions. In other embodiments, several application functions may execute on the same system. In the case of database applications, the database is may reside on separate systems or may be implemented in a distributed matter, with selected portions of a particular database or database(s) residing within the same or different systems but logically separated therefrom. Such alternative implementations provide more scalable and redundant functionality across the network environment. As indicated previously, any of the above-mentioned systems may reside within private network, an intranet, extranet, or on the Internet or other publicly accessible networks, with or without protection of a dedicated firewall server or appliance.

Having described the system hardware, network and logical organization of the inventive system, a description of individual inventive algorithms and techniques is set forth below with respect to the individual flowcharts, conceptual diagrams and graphic user interfaces of the Figures.

Auction/Event Scheduler

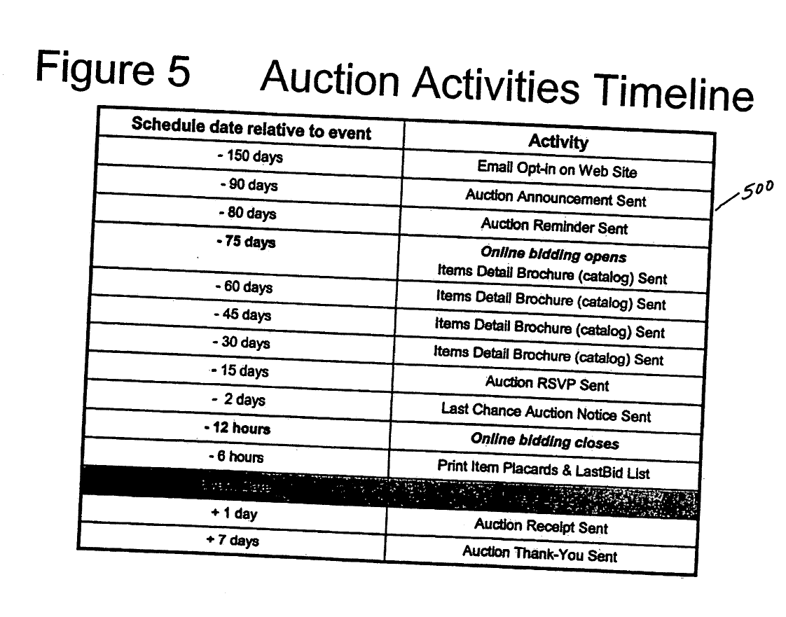

According to one aspect of the invention, the auction committee for a charitable client is able to specify a date for either a physical or virtual auction and have the inventive system generate a calendar of future events and dates relevant to the auction. Specifically, a charitable client user enters a date for a physical or virtual auction. Based on the designated date, the inventive system 1) creates a series of tasks, such as auction announcement, auction RSVP, first catalog publication, etc.; 2) suggests dates by which those tasks should be completed; and 3) a series of automatically generated electronic mail are sent notifying the auction committee in advance of the completion date for each task so that action can be taken to send the communications out. With the inventive system 250, the list of activities and suggested dates, as illustrated in FIG. 5, can be modified to suit the needs of the nonprofit or charitable client. As illustrated in the conceptual diagram 500 of FIG. 5, a number of activities occur or days and hours before the auction advance as well as afterwards. When a single date is changed the charitable client user can have the system 250 adjust all the subsequent dates accordingly or only change the single date. The charitable client user can ‘reset’ the dates to the original via a reset button, if desired. The generation of electronic mail is adjusted accordingly to the new dates. When the communication is sent to the electronic mail list an acknowledgement electronic mail is delivered to the auction one committee with the success measurements and next steps indicating the total number of electronic mail sent, the total number of electronic mail successfully received, the next steps in the process.

Alternatively, the charitable client user may also request that that the system automatically sends the communications without intervention. In such instance the system 250 would prompt the charitable client user to assign one of the templates described herein for each communication and then assign one or more electronic mail lists to the communication. At a predetermined number of days after the passing of the desired date, where the number of days is defined by the assistance server application 432, if certain database conditions which indicate that the step has taken place do not exist, the database will 1) populate a non-public web page that will send code to the CRM module 292 which will, in turn, create a service “case” or event in the CRM system that will alert the staff of system 250 to make contact with the charitable client user to assist him/her/them in completing the overdue task, typically by sending the customer an electronic mail offering assistance in completing the task.

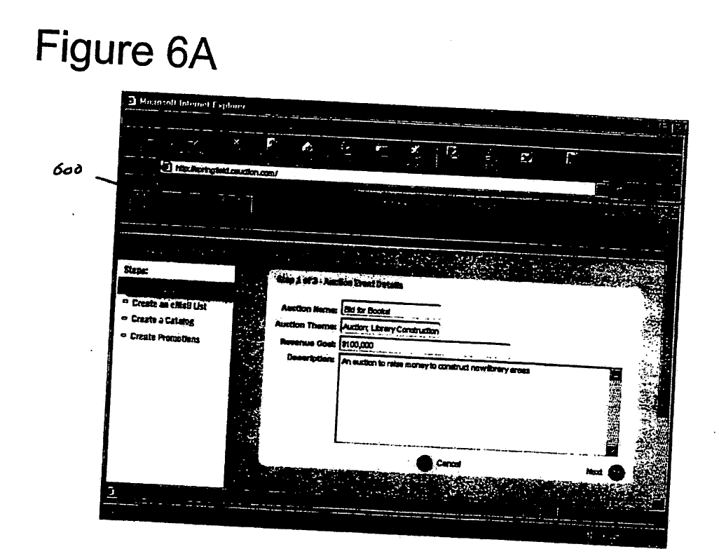

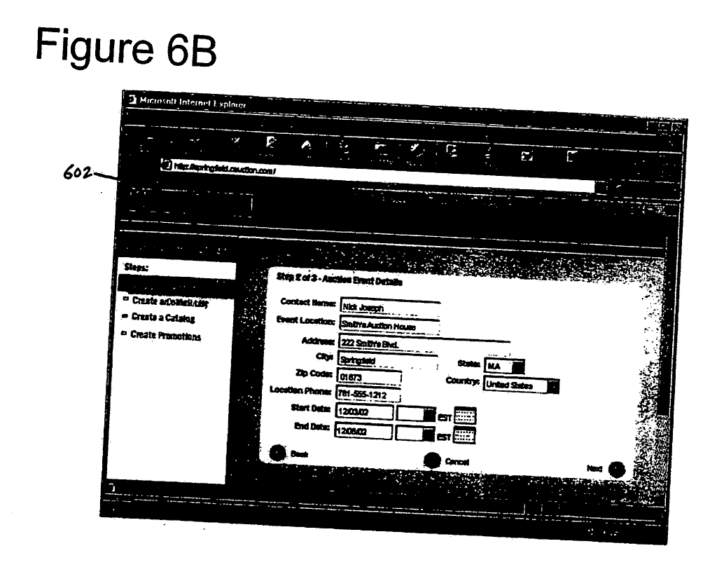

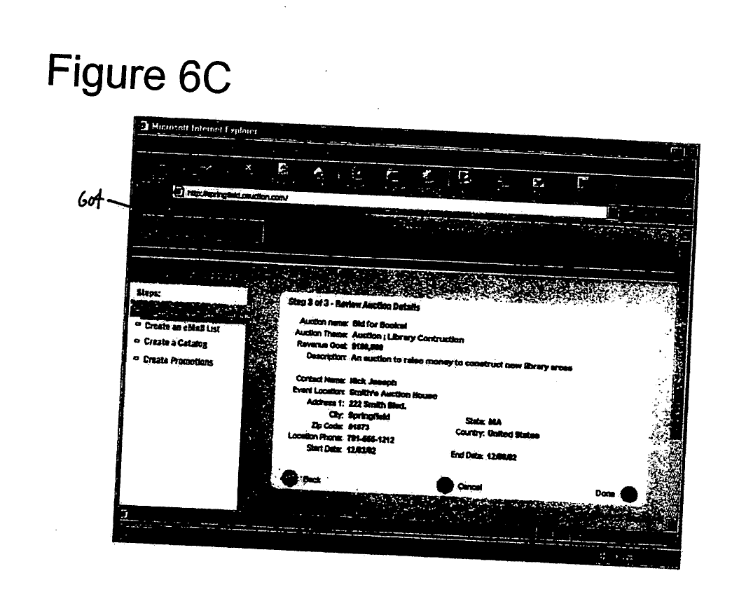

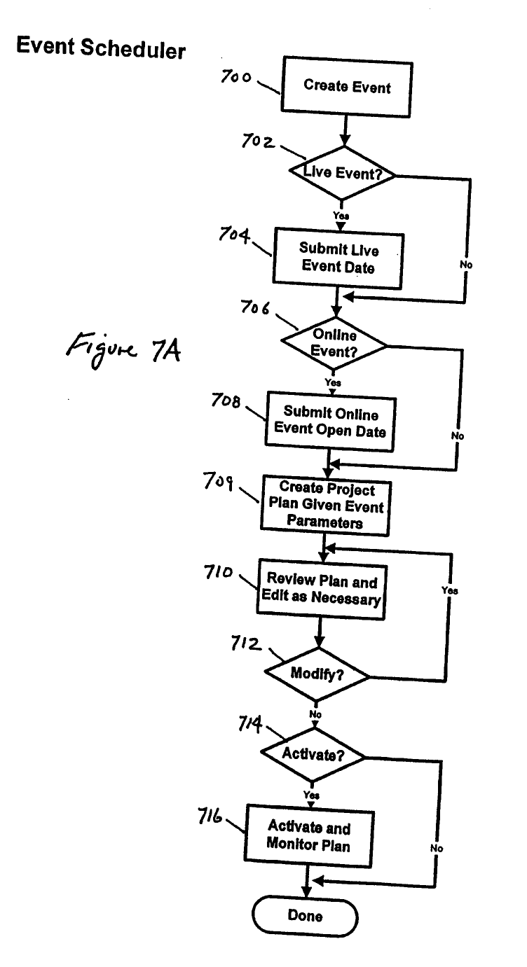

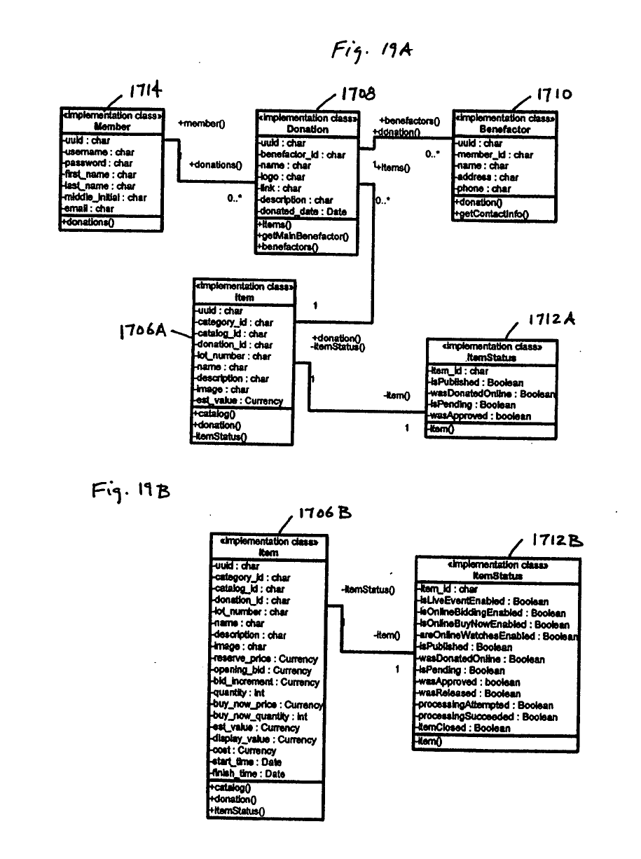

FIGS. 6A-C illustrate conceptually the graphic user interface(s) 600, 602 and 604, respectively, and algorithmic processes associated with the processes of creating an auction event in accordance with the system 250 of the present invention. The components which comprise these user interface(s) are typically stored as objects or components which collectively comprise one of the templates to stored in database 432 and modifiable using template editor 294. These templates utilize the windowing functionality in the local operating system. For UNIX-based systems, X-windows functionality may be utilized. The record structure of these templates is described with reference to FIG. 21 and its accompanying description.

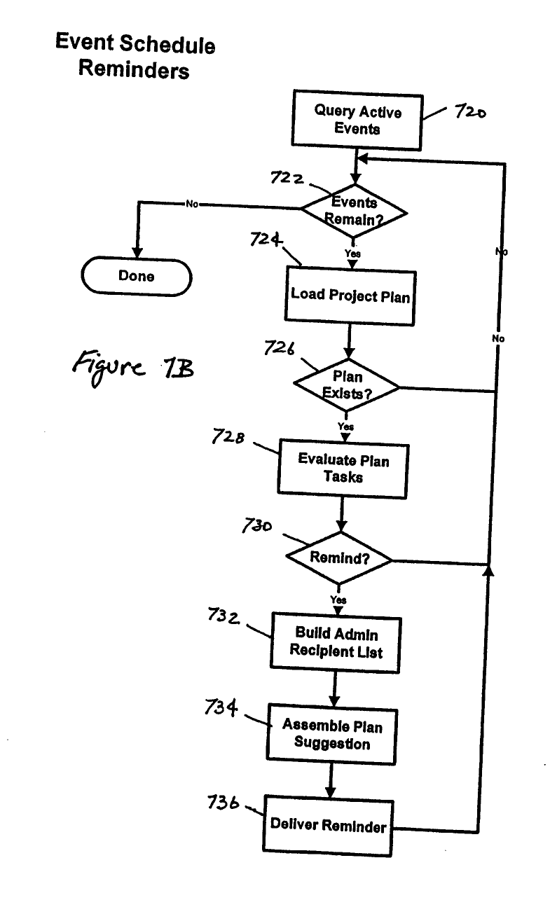

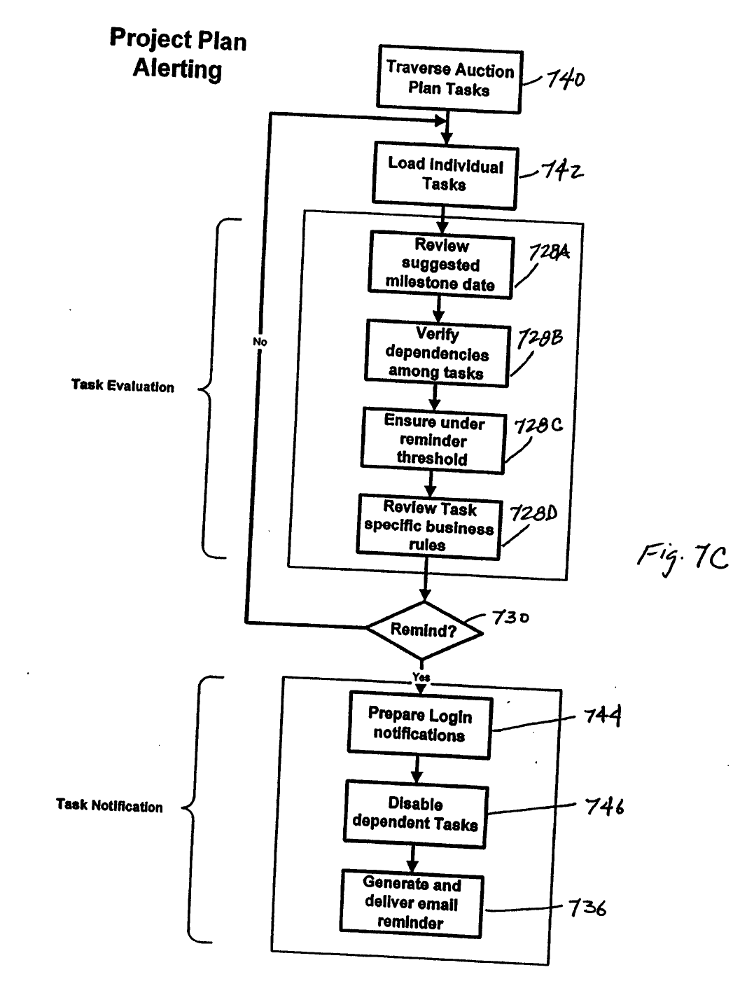

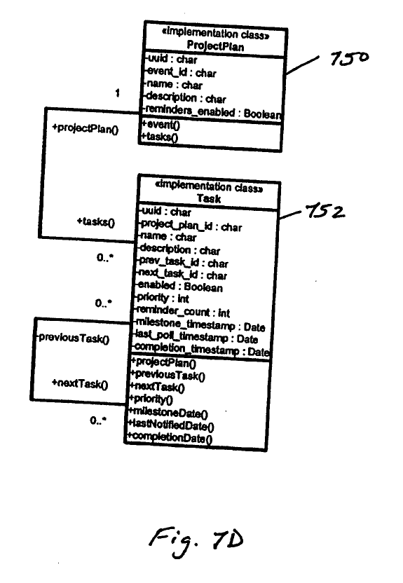

FIGS. 7A-B are flowcharts of the algorithmic process utilized to create an auction event. These processes are typically performed with a charitable client process connected to system 250 and interacting with the web pages and templates as illustrated in FIGS. 6A-C. Referring to FIG. 7A, the charitable client user, who is typically a member of an auction committee for the nonprofit organization or charity, selects the Create an Auction tab from the web pages illustrated in FIG. 6A. The charitable client user specifies the auction name a theme, revenue goal and description in the dialog boxes of the template illustrated in FIG. 6A and process block 700. Next, if the charitable client user specifies a live event, an event date is submitted, as illustrated by decision block 702 and process block 704. Alternatively, if an on-line event was a specified, and event open date is submitted, as illustrated by decision block 706 and process block 708. Next, the various event parameters are submitted using the dialog boxes, as illustrated by process block 709. These parameters can include any of a contact name, event location address, phone number, events start date and event end date, as illustrated in the template of FIG. 6B. The CRM module 292 stores all the event parameters and displays them through web page similar to that illustrated in FIG. 6C, allowing the charitable client user to review and modify any of the parameters, as illustrated by process block 710 and decision block 712. Once the auction details have been reviewed and accepted the auction is activated by submitting the data to the system as an auction event object, as illustrated by decisional block 714 and process block 716.

Having created an auction object, the system 250 generates the list of activities and suggested dates, as illustrated in FIG. 5. FIG. 7B is a flowchart of the algorithmic process utilized to generate the event reminders listed in FIG. 5. First, the auction services module 296 queries and auction object representing an active event, as illustrated in process block 720. Next, a determination is made if any events are remaining, as illustrated by decisional block 722. If no events are remaining, the process terminates otherwise, the project plan associated with the created auction object is loaded, as illustrated by process block 724. If a project plan exists, a determination illustrated by decisional block 726, and evaluation is performed of the tasks required, as illustrated by process block 728. In illustrative auction services module 296, and the subcomponent applications associated therewith, evaluates the project plan associated with the active event to determine if any reminders are required at the current time. This process typically entails the auction services module reviewing whether a particular task has been performed, as monitored by the system 250 or as indicated by the charitable client, within a predetermined number of days from the intended task completion date, as illustrated by decisional block 730. For example, referring to FIG. 5, assuming that and evaluation of a live auction is occurring 90 days prior to the event date, system 250 will determine whether auction announcements have been sent. If not, module 296 and will generate and administration recipient list from the parties, typically the auction committee, associated with the auction object, as illustrated by procedural block 732. Next, depending on the nature of the incomplete task and the reminder necessary, module 296 will assemble a list of one or more project plan recommendations, as illustrated by procedural block 734. Such a recommendations may be generated from the truth tables containing one or more required recommendations when a particular condition or scenario is true. Finally, the generated recommendation(s) are delivered to the contact name associated with the auction object and any other recipients designated by the charitable client via electronic mail or other forms of communication, as illustrated by process block 736. Thereafter, the process repeats.

Creating a Community

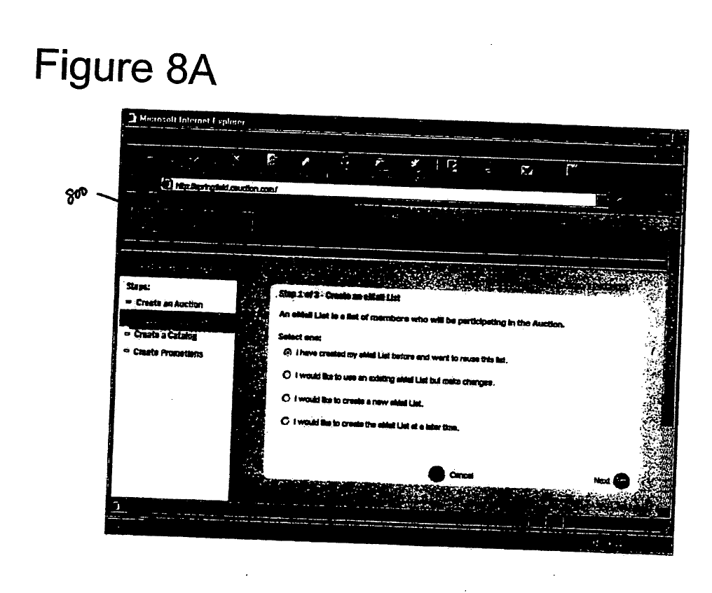

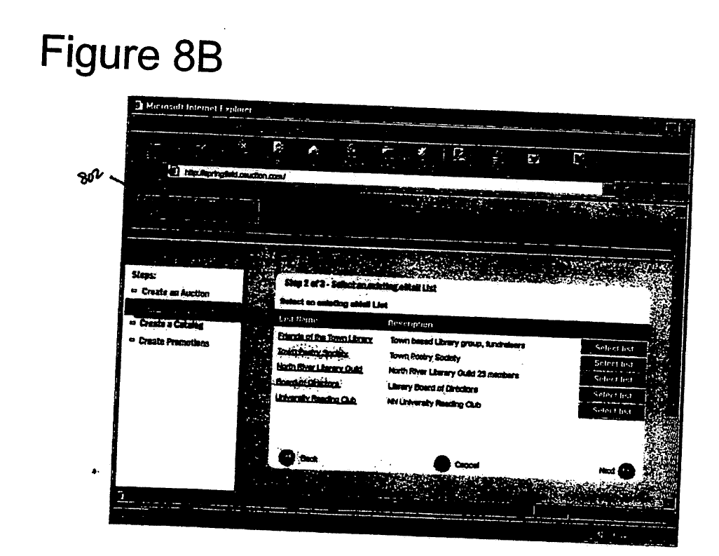

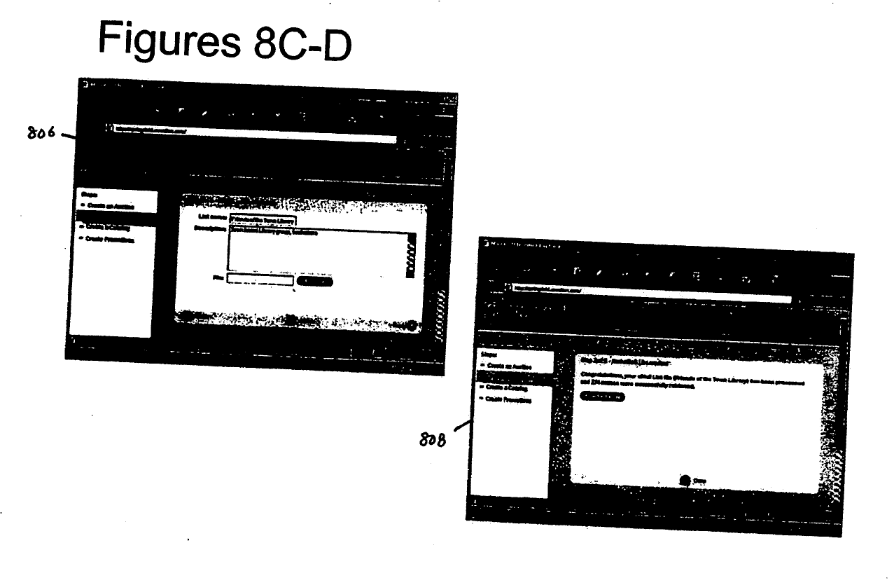

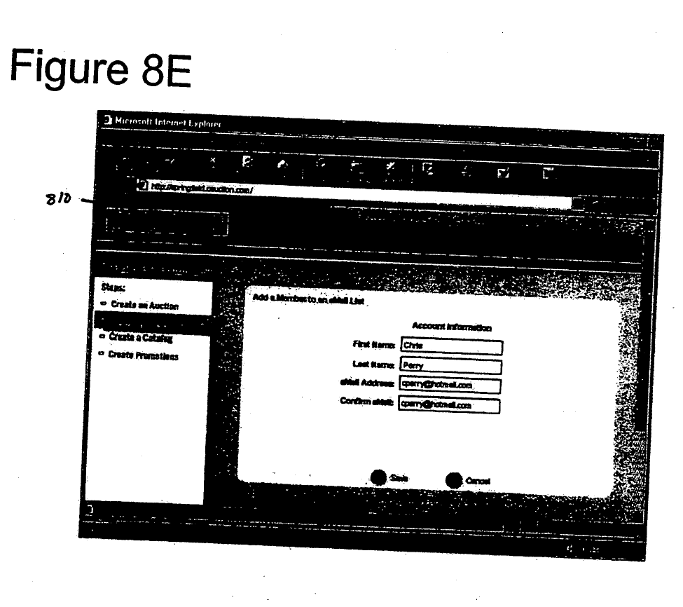

In addition to the finding the auction event using the templates and graphic user interfaces presented by system 250, the charitable client may also define the their constituency or community of potential donors for the auction event. FIGS. 8A-E illustrate conceptual graphic user interfaces of the web pages 800, 802, 804, 806, 808, 810, respectively, in accordance with the inventive system, as would be displayed to a charitable client who is utilizing the services of the inventive system. In FIG. 8A, the charitable client user, who is typically a member of an auction committee for the nonprofit organization or charity, selects the “Create an eMail List” tab from the web page illustrated and designates that a previously created electronic mail list is to be used. In FIG. 8B, a listing of existing electronic mail list is presented with selection tabs for the charitable client user to select which of the lists to associate with the auction. Upon selection of a preexisting list or the completion of a new list, the dialog box illustrated in FIG. 8C will be displayed. Alternatively, if in the user interface of FIG. 8A, the charitable client had selected the third option to create a new electronic mail list, the user interface illustrated in FIG. 8D would be displayed. If in the user interface of FIG. 8A. The charitable client had selected the second option to modify an existing electronic mail list, the user interface illustrated in FIG. 8E would be displayed. In this manner, the online constituency for the auction event may be generated efficiently.

Community Builds Electronic Mail Lists

According to another aspect of the invention, system 250 enables a charitable organization to send an electronic mail based communication to their constituency (constituents) to ask for electronic mail referrals (contacts) or, alternately, to incorporate a ‘community email button’ on all web pages and communications that allows constituents to add contacts. A constituent selects a web link, either embedded in the email or as a result of clicking on the community email button, to transfer to a data entry page where a contacts' information (name, email, etc.) can be captured. The inventive system automatically generates a personalized electronic mail that includes the constituent name, to the submitted contact enabling the contact to opt-in to the nonprofit's email database. The contact may opt-in, at the discretion of the nonprofit, for different email communications (auction only, general communications, further fund-raising solicitations, etc.). After the contact has opted in, the system automatically informs, via electronic mail, the constituent that one of their contacts has opted in. The constituent, via a web-based ‘dashboard’, may view the status of each contact that they have submitted.

According to another aspect of the invention, once all of the objects that comprise an option have been created, the inventive system 250 allows a client process to replicate an auction including auction home page and templates that have been edited with links, logos, marketing information, banners, etc., resulting in a copy of the auction and all the associated pages, community lists, etc., but on a new URL, so that a new auction is created that can then be used as is or edited to customized for a particular event. Replication of the auction saves time, particularly for charitable organizations that have such a fund raising events are on a regular basis.

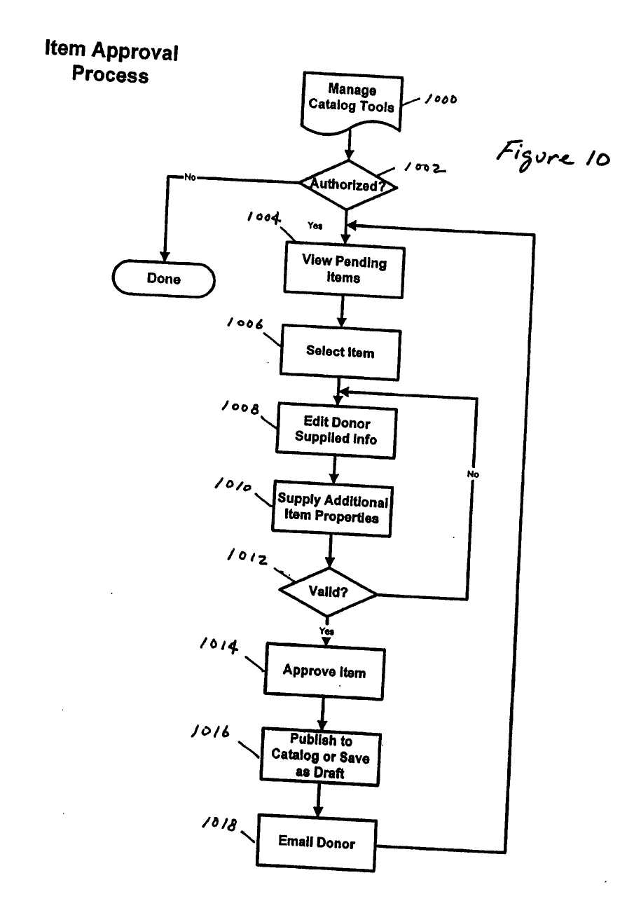

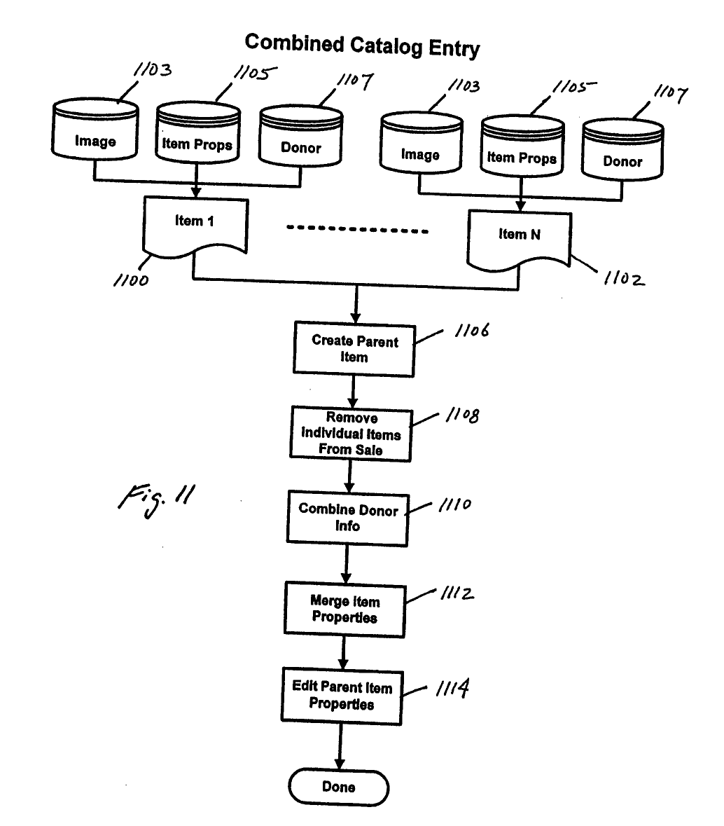

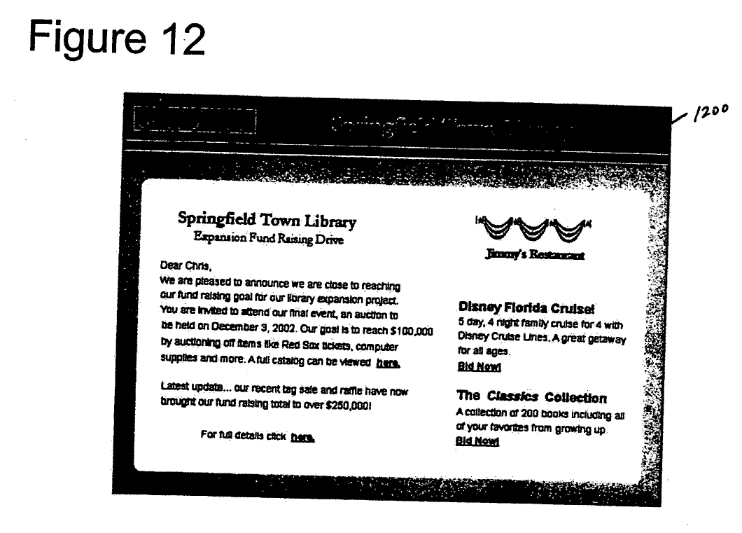

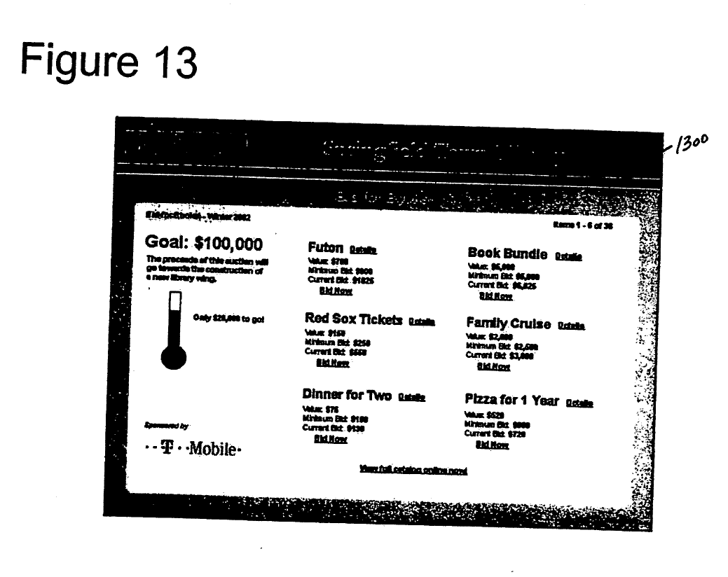

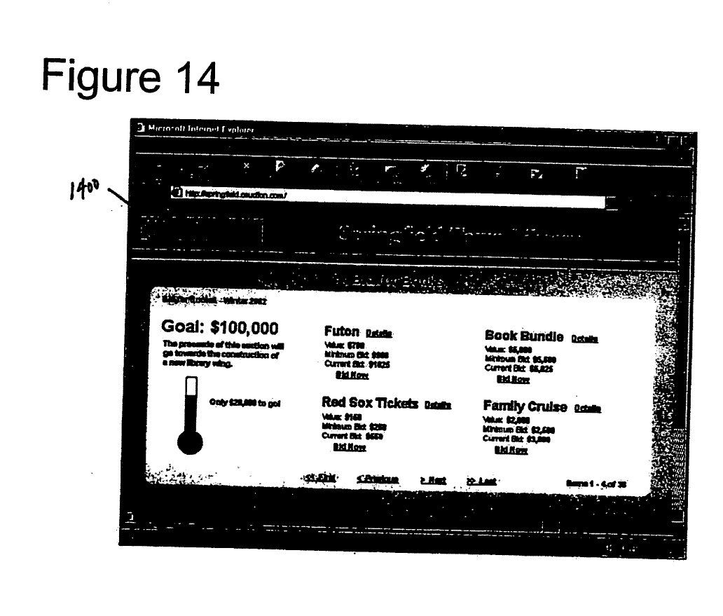

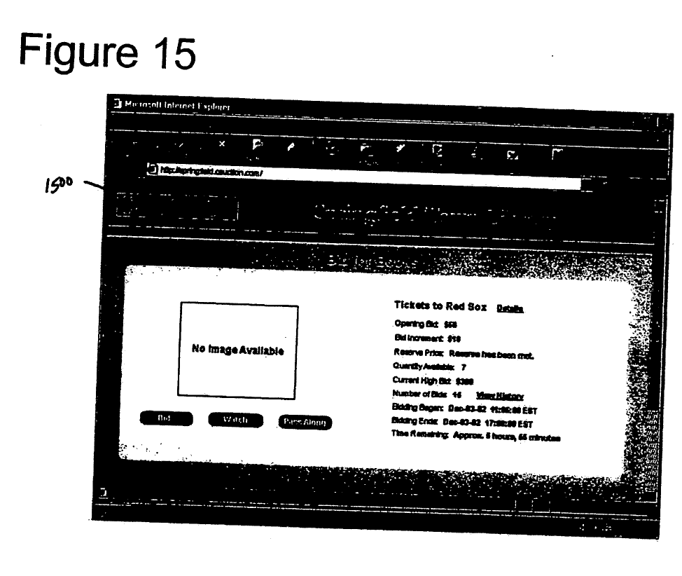

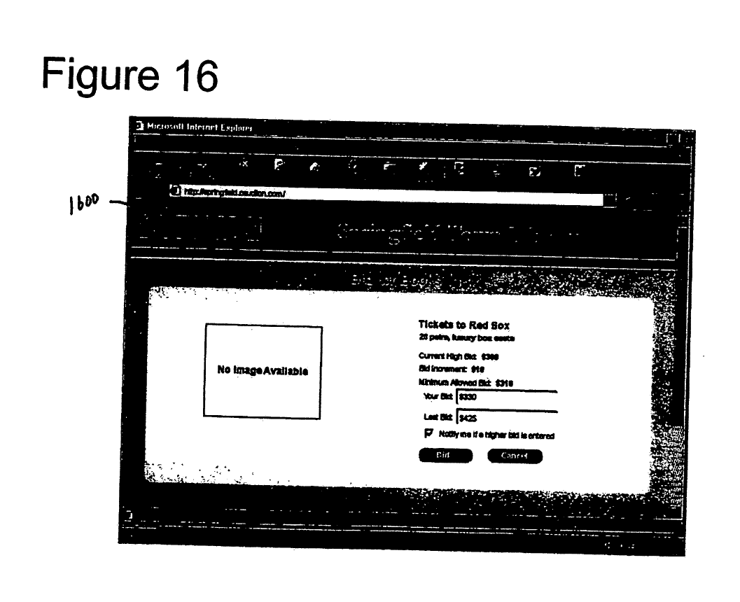

FIGS. 12-16 illustrate conceptual graphic user interfaces of the web pages 1200, 1300, 1400, 1500, and 1600, respectively, of a charitable auction, similar to that as would be experienced by bidder/donor processes 220A-B, when viewing the auction catalog online. FIG. 12 illustrates the web page displayed to a bidder/donor process upon accessing the portion of the web server dedicated to a specific auction, which includes an online invitation to a live auction event as well as highlighted items from the published virtual catalog associated with the auction. FIGS. 13-14 illustrate web pages showing selected published items from the catalog associated with the auction event. Virtual online catalog allows easy browsing and paging through all items associated to a particular catalog. Navigation from one catalog to another maintains all appropriate branding for the particular catalog and organization. Each option item displays value, minimum bid, and current bid price is, as well as links to further details for the item and two bid on the item. Each page further includes a link to view the catalog online, a listing of the auction and the current page of the total page number, as well as an indicator of the current amount raised by the auction event. The page also includes a sponsor logo. FIG. 15 illustrates a web page showing the details of a particular auction item, in this example Red Sox tickets, as would be presented upon selection of the Details link from a catalog web pages of either of FIGS. 13-14. FIG. 15 illustrates a number of parameters related to the auction item, including the opening bid, bid increments, reserve price, quantity available, current high bid, number of bids, bidding starts time, bidding and time, and total time remaining to bid, as illustrated. In addition, an image of the item may be optionally displayed along with selectable tabs to either bid on the item, watch the item or pass the link to the item to another potential bidder. Upon selection of the bid tab, a user interface similar to that illustrated in FIG. 16 will be displayed including selected of the information displayed in FIG. 15 along with the dialog boxes for entering a current bid and a maximum (last) bid, as illustrated. In addition, an image of the item may be optionally displayed along with selectable tabs to either bid on the item or cancel a bid.

Creating and Building a Catalog

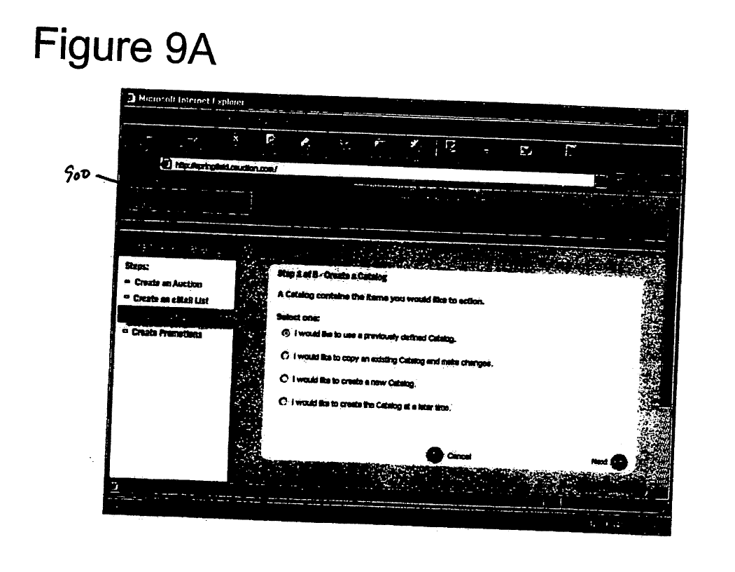

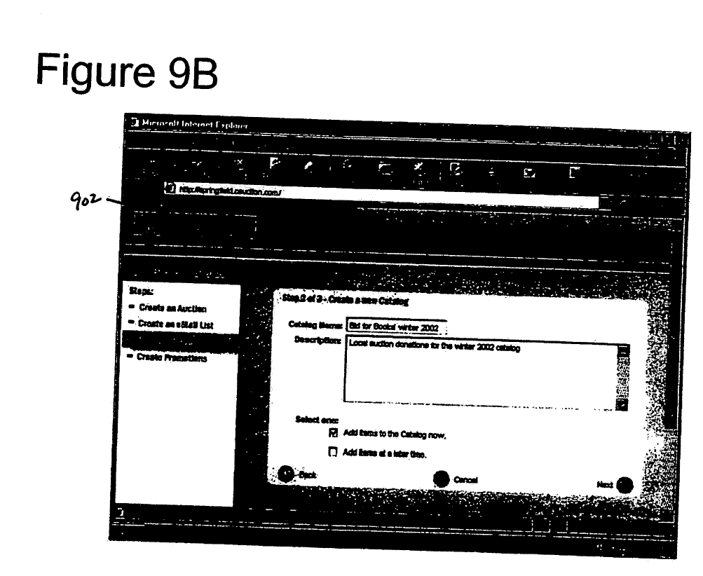

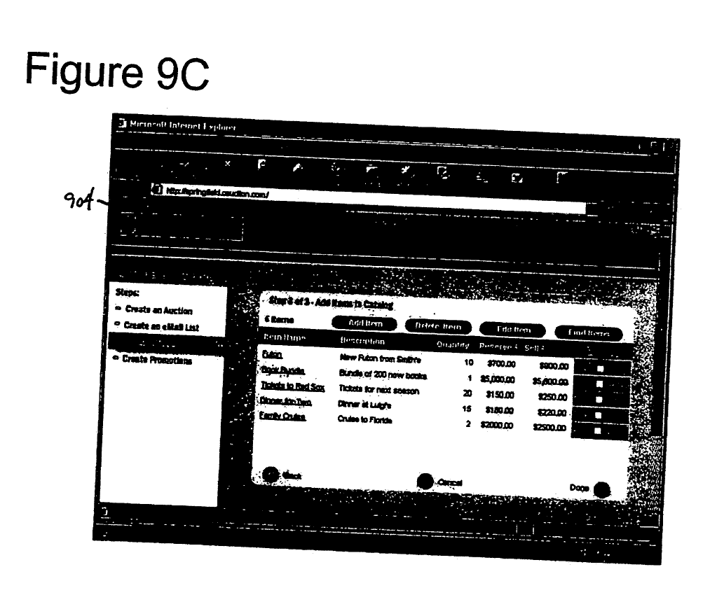

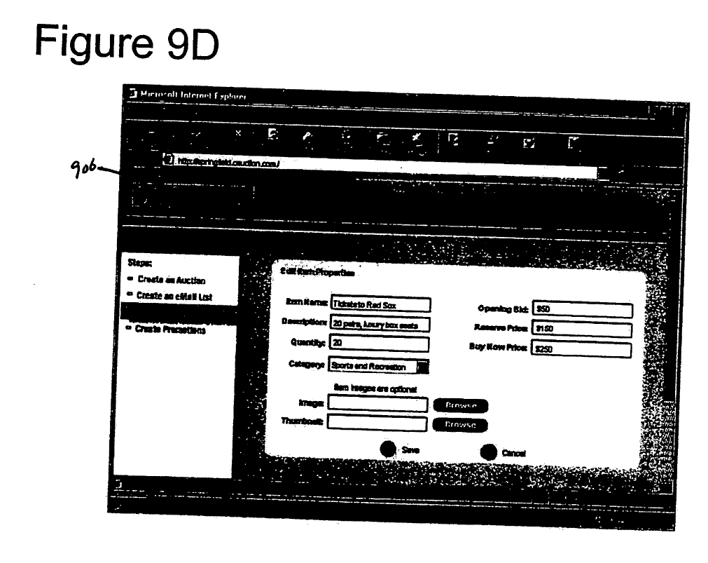

FIGS. 9A-D illustrate conceptually the graphic user interface(s) of web pages 900, 902 904, and 906, respectively, that a charitable client may utilize to create a catalog of items for an auction event, in accordance with the inventive system 250. In FIG. 9A, the charitable client user, who is typically a member of an auction committee for the nonprofit organization or charity, selects the “Create a Catalog” tab from the web pages illustrated and designates that a new catalog is to be created. Next, the user interface illustrated in FIG. 9B would be displayed. This web page enables the charitable client user to designate a catalog name and description and to selectively add catalog items, as illustrated.

The inventive system 250 enables a nonprofit or charitable client to request that their constituency donate items for an auction, either via electronic mail with an embedded link or through an embedded icon on a web page. The link embedded in the electronic mail or the embedded icon on the web page leads to a catalog item entry web page. If enabled by the charitable organization, the constituent can assign the item to a particular participant, cause, chapter, or organization for credit.

Donated items are queued for review within the inventive application that is restricted to viewing by auction committee members with correct permissions. Committee members can either accept, edit or reject items within the queue. When a committee member approves an item an automatic electronic mail notification is sent to the donating party. When a committee member edits an item an automatic electronic mail notification may be generated and sent to the donating party with the changes highlighted. Similarly, when a committee member rejects an item an automatic electronic mail is generated and sent to the donor with the reason for the disapproval. Upon approval, the item is added to the auction database and published to a database-served auction catalog based upon the ‘born on’ date or, if a ‘born on’ date is not present, the item may be published immediately. Donors can view a ‘personal page’ that lists the items that they have donated and their current status; in queue, accepted, rejected, and, if already accepted and in the auction process, the current bid status. When an item is sold an automatic electronic mail may be generated and sent to the donor with an IRS-acceptable donation receipt (electronic) attached. The above described process is set forth in greater detail with reference to FIG. 10.

Referring to FIG. 10, the process utilized by the charitable client, typically an authorized member or administrator of the auction committee for the charitable client, to approve or reject an item submitted by members of the constituent community using the catalog item entry web page of system 250 accessed using the previously described processes of an embedded link in the electronic mail or an embedded icon on the web page. The data parameters describing item submitted by the constituent community using the catalog item entry web page are placed in memory, as database records or objects, and designated as pending items for the review by an authorized member of the auction committee. The charitable client user accesses the web page presented by auction web server 260 for managing catalog tools, as illustrated by process block 1000. The system checks to authenticate the user, as illustrated by decisional block 1002, and, if authorized, views the records of pending items that have been submitted by the constituent community, as illustrated by process block 1004. Next, a listing of pending donated items, as illustrated in the user interface of FIG. 9C, is displayed with tabs allowing the items to be added to the current catalog, deleted from the current catalog, edited or a search query initiated. If the user selects to edit a catalog item, as illustrated by process block 1006, the user interface illustrated in FIG. 9D is presented which enables the editing of the donor supplied item parameters illustrated, as illustrated by procedural block 1008. Once the client process representing an authorized auction administrator has finished editing the parameters of the selected catalog item, the item can be approved through selection of the Add Item tab from the user interface enabling the submission of the additional item properties and updating the status of the item to “approved” and submitting the item to the catalog for publication, as illustrated by blocks 1010 through 1016. Alternatively, the client process user could save the edited item as a draft for later evaluation and/or publication, as illustrated by process block 1018. Acceptance, rejection or modification of the parameters of a donor supplied item generates an electronic-mail message to the donor constituent explaining the same, as illustrated by procedural block 1020. The item review process may repeat thereafter for other pending items currently submitted or upon submission prior to the auction event. In this manner, the catalog for the auction event may be generated efficiently.

In the illustrative embodiment, the data structures processed by the inventive algorithms described herein are implemented in an object-oriented format with data records implemented as objects having both data and methods, as applicable. Referring to FIGS. 17-19, the implementation class definitions of the data structure objects useful for implementing the inventive concepts in an object-oriented environments, particularly the data and methods described herein, are illustrated. These record objects may be stored in any of the databases illustrated in the figures and may include data which simultaneously resides as parts of other records in other databases. The data-types of the data variables contained within the records are illustrated in FIG. 17-21 and, e.g. char, date, Boolean, currency, etc., selected of which are explained in greater detail hereafter. In the record objects of FIGS. 17-19, selected relevant methods utilized by one object to call another object are designated with the following form: “methodname( )” where the actual name of the method will replace methodname. Also, a “1” associated with a method indicates that there can be only one valid data value for the queried object while a “0.*” associated with a method indicates that there can be multiple valid data value(s) for the queried object.

FIGS. 17-20 illustrate the relationship between Event Record 1700, Organization Record 1701, Catalog Record 1704, Item Record 1706, Donation Record 1708, Benefactor Record 1710, Item Status Record 1712, and Member Record 1714. Primary records maintained for an auction include Organization Record 1701, Event Record 1700, and Catalog Record 1704. In the illustrative embodiment, all auctions all have an Organization Record 1701. In the illustrated embodiment, Organization Record 1701 comprises the following variables:

uuid
name
alias
description

The nature of the data type used to implement each variable is illustrated in FIG. 17. In Organization Record 1701 the uuid is a unique universal identifier and may be implemented with a multiple bit field of alphanumeric data. The uuid data serves as a primary key to identify an organization, e.g. the nonprofit or charitable or other entity holding the event. The name and description variables describe the name and nature of the organization, respectively, while the alias data may be used to describe an alternative name for the organization. In addition, the organization record has two methods associated therewith. As illustrated in FIG. 17, the +events( ) method can be used to call up one more events associated with the organization using the appropriate events identifier. Similarly, the +catalogs( ) method can be used to call one more catalogs associated with the organization using the appropriate catalog identifier.

In the illustrative embodiment, on-line auctions and combined on-line/live event auctions have Event Records 1700. In the illustrated embodiment, Event Record 1700 comprises the following variables:

uuid
organization_id
name
event_type
chairperson
description
start_time
finish_time

The nature of the data type used to implement each variable is illustrated in FIG. 17. In Event Record 1700 the uuid may be implemented similar to record 1701 and serves as a primary key to identify an auction. The organization_id variable identifies the parent organization, e.g. the nonprofit or charitable entity holding the event. The event_type variable identifies the event as being Online, Live Event or Both. The name and description variables describe the name and nature of the event, respectively. The chairperson variable identifies the chairperson associated with the event, respectively. The start_time variable identifies the date and time at which the event commences. The finish_time variable identifies the date and time at which the event ends. As illustrated in FIG. 17, the +catalogs( ) method can be used to call one more catalogs associated with the organization using the appropriate catalog identifier.

A Live Event record exist only for auctions which have a corresponding live event. The Live Event record, not shown in the figures, comprises the uuid, start_time, and finish_time variables similar to those described with reference to Event Record 1700. In addition, Live Event record comprises an event_id variable that identifies the corresponding Event Record 1700 to which the live event record corresponds.

Catalog details are maintained in the Catalog, Item, Donation and Benefactors records as described herein. One or more Catalog records 1704 can exist for each Event Record 1700. Multiple catalogs allow the separation of Online and Live Event items, if desired. In this manner, a different set of auction items may be available for an online auction event than those offered at a corresponding live auction event. In the illustrated embodiment, Catalog Record 1704 comprises the following variables:

uuid
organization_id
event_id
name
description
start_time
finish_time
points
donation
absentee_bidding

The nature of the data type used to implement each variable is illustrated in FIG. 17. In Catalog Record 1704 the uuid data may be implemented similar to record 1701 and serves as a primary key to identify a catalog. The organization_id variable identifies the parent organization, e.g. the nonprofit or charitable entity holding the event. The event_id variable identifies the corresponding Event Record 1700 to which the live event record corresponds. The name and description variables describe the name and nature of the catalog, respectively. The start_time variable if present, overrides the event start date and time. The finish_time variable, if present, overrides event close date and time. The remaining fields with in the Catalog Record 1704 are optional. The points variable is a flag to indicate if a rewards program enabled. The donation variable is a flag to indicate if donations are accepted. The absentee_bidding variable enables absentee bidding in live events. As illustrated in FIG. 17, the +items( ) method can be used to call one or more items associated with the catalog using the appropriate item identifier.

Item properties are stored in item records, with additional status and flags maintained in Item Status records, as illustrated. An Item Record 1706 exists for each item associated with a particular Catalog Record 1704 and has the form illustrated in FIG. 17. In the illustrative embodiment, items may be a composite parent auction item or be a component thereof as described herein. In the illustrated embodiment, Item Record 1706 comprises the following variables:

uuid
category_id
catalog_id
donation_id
lot_number
name
description
image
reserve_price
opening_bid
bid_increment
quantity
buy_now_price
buy_now_quantity
est_value
display_value
cost
start_time
finish_time

The nature of the data type used to implement each variable is illustrated in FIG. 17. In Item Record 1706 the uuid variable serves as a primary key to identify an item. The category_id variable identifies the item category of the auction item. The catalog_id variable identifies the catalog record of the auction item. The donation_id variable identifies the donation record if the item was donated by constituency. The optional lot_number variable identifies the lot of the auction item. The name variable identifies the name of the auctioned item. The description variable provides a description of the auctioned item. The image variable identifies the name of the image file associated with the auctioned item and a link, where applicable. In the illustrative embodiment, the image file may be stored on a webserver, with only the name referenced in one of the local databases of system 250. The image file may be formatted in any number of conventional image data formats, including, but not limited to JPEG, GIF, PNG, etc. The reserve_price, opening_bid, bid_increment, and buy_now_price identify the amounts in currency of the reserve price, opening bid, bid increment, buy item now price of the auction item, respectively. The quantity variable identifies the number of auction items available. The buy_now_quantity variable identifies the number of auction items available or that must be purchased to achieve the buy_now_price. The est_value variable identifies the estimated value (fair market value) of the item used for printing purchase receipts. The display_value variable identifies the estimated value to be display in either the printed or on line catalog associated with the auction item. The cost variable identifies the amount in currency of any cost to purchase the auction item, or component auction items, if any. The start_time variable identifies the date and time at which the auction for the item commences. The finish_time variable identifies the date and time at which the auction for the auction item is complete.

In addition, the organization record has six methods associated therewith that can be used to call other records containing data values related to the item record. As illustrated in FIG. 17, the +catalogs( ) method can be used to call one more catalogs associated with the organization using the appropriate catalog identifier. The +donation( ) method can be used to call up the record associated with the using the donor using the appropriate identifier. Similarly, the a plurality of method, the +itemsStatus( ) method can be used to call the status data associated with the item the appropriate itemStatus identifier.

An ItemStatus record 1712 exists for each item associated with a particular item record 1706 to maintain additional status and flags, as illustrated in FIG. 17. The data type used to implement each variable in ItemStatus record 1712 are either char or Boolean. In addition a single method, item( ) can be used to identify the item to which the status information relates.

A Donation Record 1708 exists if an item has been donated by the auction constituency. In the illustrated embodiment, Donation Record 1708 comprises the following variables:

uuid
benefactor_id
name
logo
link
description
donated_date

The nature of the data type used to implement each variable is illustrated in FIG. 17. In Donation Record 1708 the uuid variable serves as a primary key to identify a donor. The benefactor_id variable identifies the benefactor record if the parent item was donated by constituency. The name, logo, link, and description variables describe the name, logo, on line address, and nature of the donor, respectively, whether an individual or a business entity. The donated_date variable identifies the date and time at which the auction item was donated.

According to another aspect of the invention, a nonprofit or charitable organization is able to define dollar thresholds for the appearance of donor logos and links and have the process automated by system 250. If the Fair Market Value of the item being donated, meets one of the predefined threshold criteria, whether determines by the auction committee or by a community donor, the inventive system enables ‘add logo’ or ‘add link’ graphics to be displayed when a donor is entering the information in the donor web page. The donor may then include a logo and are linked to the donor's web site which will appear in the on-line catalog, similar to that illustrated in FIG. 12. The data defining the such donor logo and link are stored in Donation Record 1708.

In addition, the Donation Record 1708 has three methods associated therewith that can be used to call other records containing data values related to the item record. The +items( ) method can be used to call one or more items associated with the donor using the appropriate donor. The +getMainBenefactor( ) and +benefactors( ) methods can be used to call one or more benefactors associated with the donor using the appropriate donor data.

In the illustrative embodiment, an item may be donated by an organization or multiple donors. In such instances, benefactor records 1710 are used to track information related to the multiple benefactors which comprises the donating entity. Accordingly, one or more benefactor records 1710 may exist for a donation record and contain appropriate contact information. In addition, benefactor records exist for donated and sponsored items. More than one benefactor is possible, each accessible via an API. Specific contact information may be available via the API for each benefactor, including name, address, contact info, etc. In addition to contact information, logos and URLs may be maintained. In benefactor records 1710 the uuid variable serves as a primary key to identify a benefactor. The member_id variable identifies the auction member who will be the benefactor of the donation. The name, address, and phone variables describe the name, address and telephone information of the benefactor of the donation, respectively. The +getContactInfo( ) and +donation( ) methods can be used to access the donation record and the contact information of the benefactor.

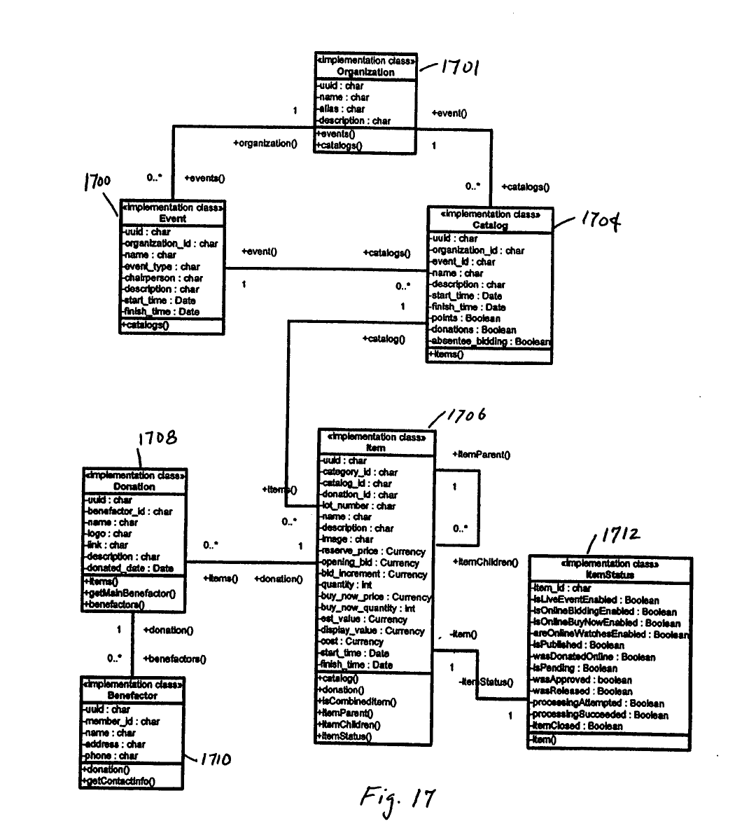

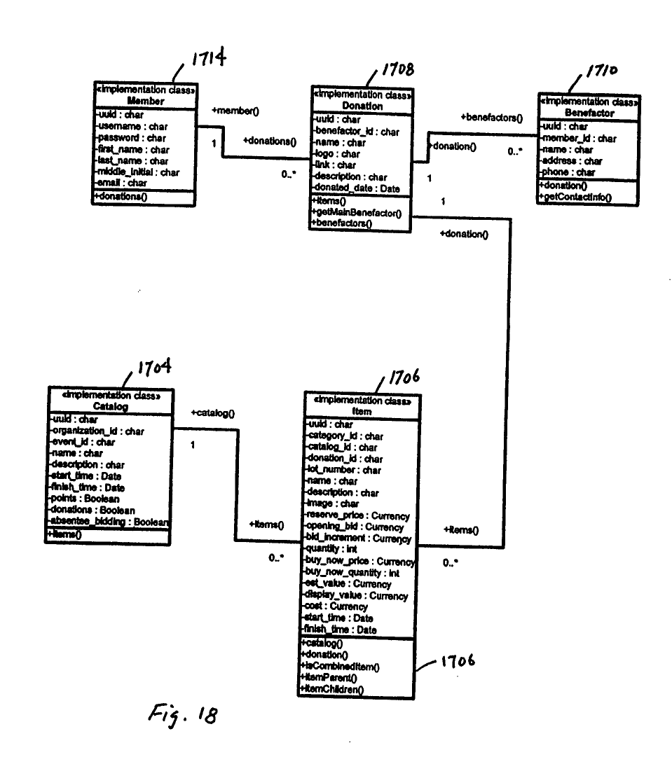

FIG. 18 illustrates the relationships among Catalog Record 1704, Item Record 1706, Donation Record 1708, Benefactor Record 1710, and Member Record 1714, and the respective methods utilized between records to access the other. In the illustrative embodiment, participants to an auction, whether as a bidder or as a donor of an item or other role, must first register with the auction as a member. The membership information is stored in Member Record 1714. The nature of the data type used to implement each variable is illustrated in FIG. 17. In Member Record 1714 the uuid data value may be implemented similar to record 1701 and serves as a primary key to identify a member. The username and password variables describe the username and password that a member uses to log-on to an on-line auction hosted by the system 250. The first_name, last_name and middle_initial fields are used to store the name of the member, while the e-mail field is used to store the electronic-mail address at which the member can be reached. The +donations( ) methods can be used to access one or more donation records associated with a member record.

In the illustrative embodiment, participants to an auction, whether as a bidder or as a donor of an item or other role, must first register with the auction as a member. On donation, a new member record is created if the donating member has not previously registered. For the donated item, the item, itemStatus, donation and benefactor records are created. Item properties are stored in item record, with additional status and flags maintained in Item Status records. On item donation, a limited number of properties are set in item and item status records. Specifically, required properties include item name, description, desired category, estimated value, and donor name. Optional properties can be specified, including special instructions and an item image. Optional donor properties may include donor link, donor logo, and donor description. Additional contact information, not accessible from member records, is available via the benefactor API. Contact information required to complete donation process.

Utilizing the process illustrated in FIG. 10, an auction administrator or other authorized party views pending items awaiting approval and determines whether or not to accept or release (reject) the donated item. In the illustrative embodiment, a query of database 1105 for items having the pending field of a specific value allows an auction administrator to review all of the pending items at a point in time. Alternatively, the data records representing pending items may be placed in an approval queue. Upon acceptance/rejection of an item, remaining item and item status properties are set. An item editor utility which enables the process as outlined herein and in FIG. 10, may be part of the Platform tools server 402, the construction and function of which is within the scope of those recently skilled in the arts given the disclosure of the procedural algorithms and data structures described herein, including the data type and methods of the relevant record objects. This is that

FIG. 19A illustrates, for a donated auction item that has been approved, the relationships among Item Record 1706A, Item Status Record 1706A, Donation Record 1708, Benefactor Record 1710, and Member Record 1714, and the respective methods utilized between records to access the other. FIG. 19B illustrates for a donated auction item that has been released or rejected, the relationships among Item Record 1706B, and Item Status Record 1706B and the respective methods utilized between records to access the other.

In the illustrative embodiment, items donated by the same member can span catalogs and organizations for any particular member. A donor page provides a single view across all catalogs to view donated items. On the member's donor page, donated items are grouped together within their relevant catalog. Donors can view a the list of items they have donated and their current status as pending, accepted, rejected, and, if already accepted and in the auction process, the current bid status.

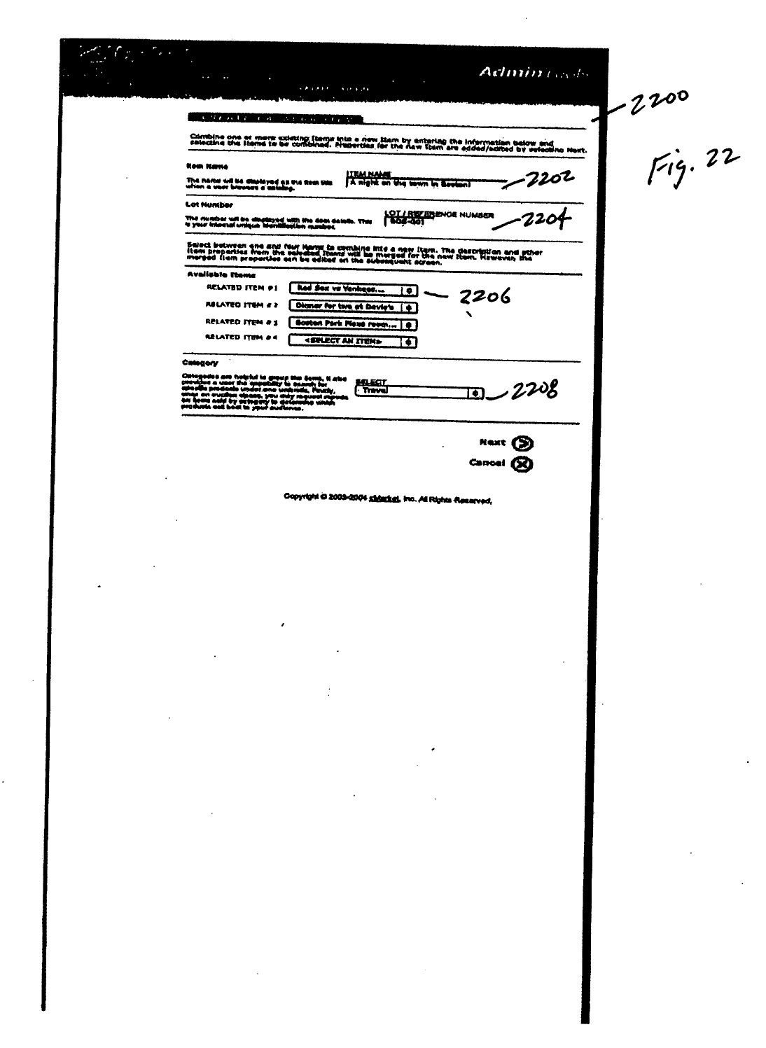

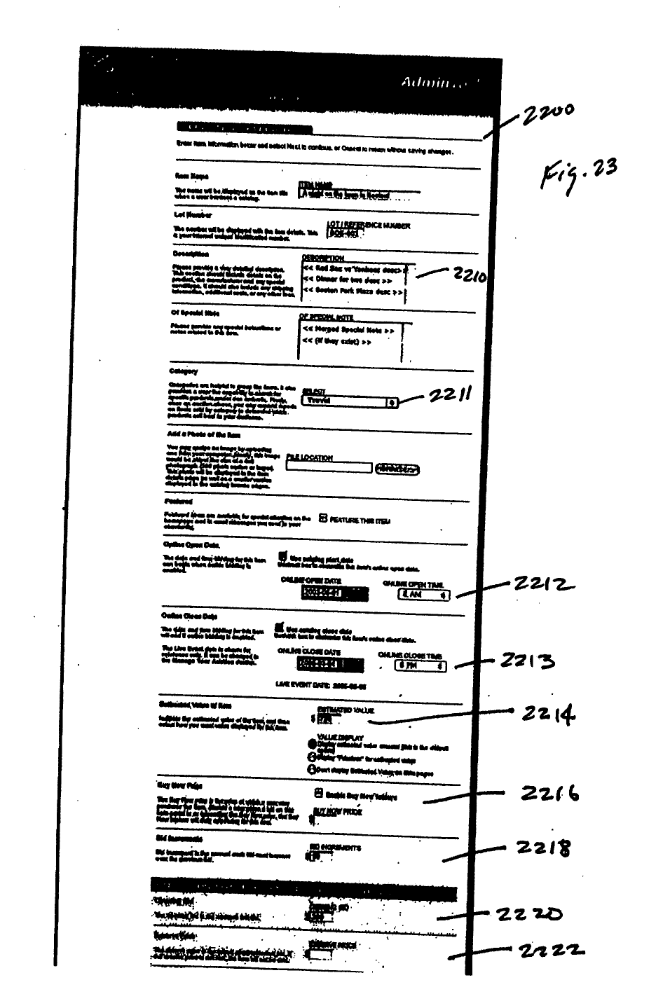

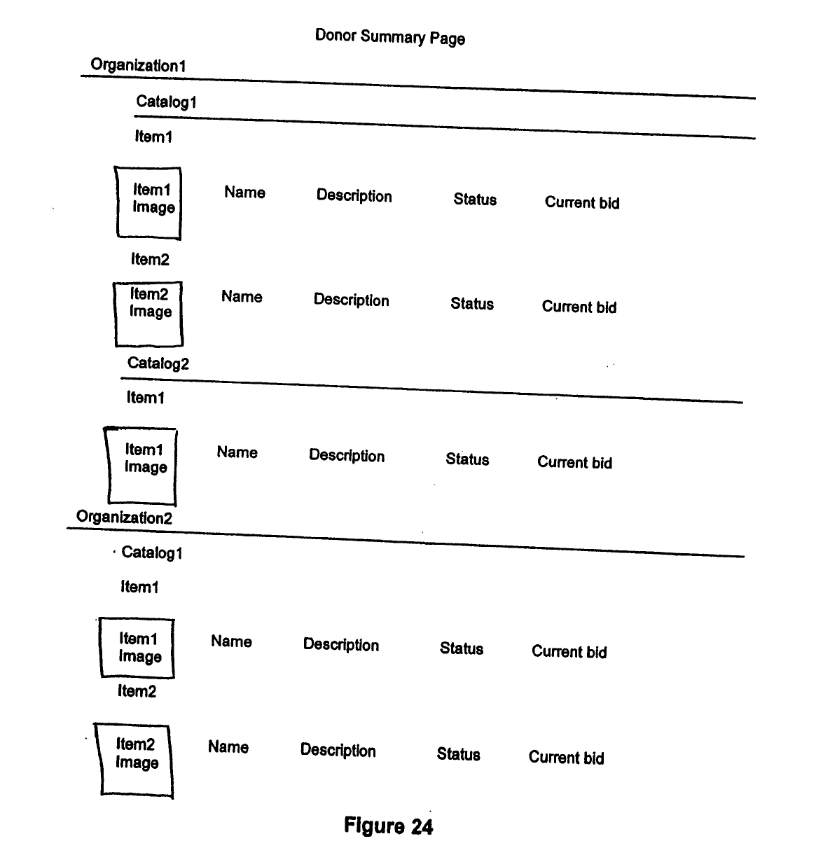

FIG. 24 illustrates an exemplary donor page in which multiple items, all donated by the same donor member are visible along with selected status information. Upon request of the member, and utilizing the record objects and methods described in the FIGS. 17-20, and appropriate set of queries are made into the respective databases, as would be understood by those reasonably skilled in the arts, given the descriptions contained herein. The resulting data is then assembled a Web page which can be displayed by the donor member. Other optional links on the Web page may provide additional information. Note that the donor page may include any relevant image files related to the respective items from the image server. The inventive system further maintains relationships among various items that enable searching capabilities such as to allow catalog viewers to sort the catalog by ‘donated to’, to enable donors to forward, via electronic mail, the catalog listing of their items.

Combining Catalog Entries

According to another aspect of the invention, once a catalog has been generated and a plurality of items donated, the inventive system 250 enables an auction committee member of a charitable organization to combine individual catalog items, either currently published or pending, into a single parent auction object that is an aggregate or composite auction item while still maintaining the integrity of the donor contribution the data of the individual components comprising parent item. For example, airfare, hotel, sightseeing items donated from various constituents can be combined into a single packaged offering having a fair market value and a starting bid which may be different than the fair market value and a starting bid of any of the individual component auction items within the parent item.

FIG. 11 illustrates in greater detail the algorithmic process utilized to combine the properties of multiple auction items to form a composite or parent item. In FIG. 11, a plurality of donated items 1100 and 1102, designated Item 1 and Item N, respectively, each have an image record stored in database 1103, an item record stored in database 1105 and donor record stored in database 1107 associated therewith. A user who has been authenticated by system 250 may combine items by creating a new ‘parent’ catalog entry with a parent item name and assigning them to the newly created name by selecting a combine item function and selecting the combined item name, as illustrated by process block 1106. Next, the individual items are removed from sale or pending status, as illustrated by procedural block 1108. The donor information from each of the individual items is combined and associated with a donor record for the parent item as illustrated by procedural block 1110. Other properties of Item 1 and Item N, such as item descriptions, images, etc. are edited, typically merged, where applicable, as illustrated by procedural block 1112. The estimated or fair market values of the individual items are combined automatically by the system 250 to generate the fair market value of the combined item. In the illustrative embodiment, there may be a drop-down menu or similarly enabled function that allows the authorized user/committee member to see other items already entered into the catalog, allowing an item that is currently being edited to be added to a parent item. Finally, the user can edit the properties of the parent item to include the same or different properties of the individual component items, as illustrated by procedural block 1114. In the contemplated embodiment, all the standard auction options, e.g. enable online bidding, LastBid, etc., are available at the parent level. Any related donor links and logos are preserved and displayed at the parent level or new donor links and logos may be entered and edited at the parent level. Any restrictions and/or special instructions are maintained and combined into a single restriction/special instruction display associated with the combined parent package. The new parent item, that results from the combination of individual items 1100 and 1102, using the above-described process, has image, auction properties and donor record values associated therewith, in the same manner as other published items in the catalog.

The above process can be better understood with reference to the specific object records involved and the relationship among such records in memory. In the illustrative embodiment, combined items are maintained via a parent item record and parent/child relationships with plural item records. FIG. 20 illustrates the relationship between a parent item record 2006A and a plurality of child item records 2006A and 2006B as well as other relevant records similar to those illustrated in FIGS. 17-19. Specifically, in FIG. 20, Event Record 2000, Catalog Record 2004, Item Record 2006B-C, Donation Record 2008, and Benefactor Record 2010 are similar in structure and implementation to Event Record 1700, Catalog Record 1704, Item Record 1706, Donation Record 1708, and Benefactor Record 1710, respectively, of FIG. 17, except where noted. In Event Record 2000, the organization_id variable identifies the parent organization, e.g. the nonprofit or charitable entity holding the event. In Catalog Record 2004, the organization_id variable identifies the parent organization, e.g. the nonprofit or charitable entity holding the event. In Donation Record 2008, the benefactor_id variable identifies the benefactor record if the parent item was donated by constituency.

A Parent Item Record 2006A exists for each composite item associated with a particular Catalog Record 2004, and, for items which are part of a composite parent auction item, an Item Record 2006B exists, as illustrated in FIG. 20. In the illustrated embodiment, Parent Item Record 2006A comprises the following variables:

uuid
category_id
catalog_id
donation_id
lot_number
name
description
image
reserve_price
opening_bid
bid_increment
quantity
buy_now_price
buy_now_quantity
est_value
display_value
cost
start_time
finish_time

The nature of the data type used to implement each variable is illustrated in FIG. 20. In Parent Item Record 2006A the uuid variable serves as a primary key to identify a Parent Item Record. The category_id variable identifies the item category of the parent auction item. The catalog_id variable identifies the catalog record of the parent auction item. The donation_id variable identifies the donation record if the parent item was donated by constituency. The optional lot_number variable identifies the lot of the parent auction item. The name variable identifies the name of the parent auctioned item. The description variable provides a description of the parent auctioned item. The image variable identifies the name of the image file associated with the parent auctioned item and a link, where applicable. As with regular auction items, an associated image file may be formatted in any number of conventional image data formats, including, but not limited to JPEG, GIF, PNG, etc. The reserve_price, opening_bid, bid_increment, and buy_now_price identify the amounts in currency of the reserve price, opening bid, bid increment, buy item now price of the parent auction item, respectively. The quantity variable identifies the number of parent auction items available. The buy_now_quantity variable identifies the number of parent auction items available or that must be purchased to achieve the buy_now_price. The est_value variable identifies the estimated value (fair market value) of the parent item used for printing purchase receipts. The display_value variable identifies the estimated value to be display in either the printed or on line catalog associated with the parent auction item. The cost variable identifies the amount in currency of any cost to purchase the parent auction item, or component auction items, if any. The start_time variable identifies the date and time at which the parent auction item is offered. The finish_time variable identifies the date and time at which the auction for parent auction item is complete.

Combined items are maintained via parent/child relationships. For combined items, the Parent item is displayed in the catalog, with attributes being derived from each child item comprising the collection. The +isCombinedItem( ) method can be used to determine that whether the subject item is part of a combined item offering. If the subject item is a component or child item of a parent item combination, the +itemParent( ) method can be used to identify the parent item. If the subject item is a parent item combination, the +itemChildren( ) method can be used to identify the any children items.

Live Event record 2002 exist only for auctions which have a corresponding live event. Live Event record 2002 comprises the uuid, start_time, and finish_time variables similar to those described with reference to Event Record 2000. In addition, Live Event record 2002 comprises an event_id variable that identifies the corresponding Event Record 2000 to which the live event record corresponds.

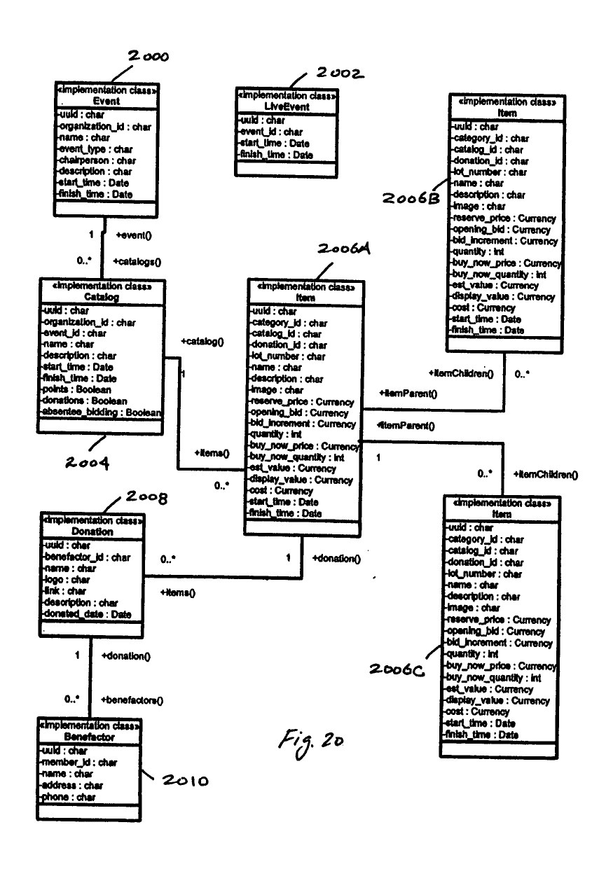

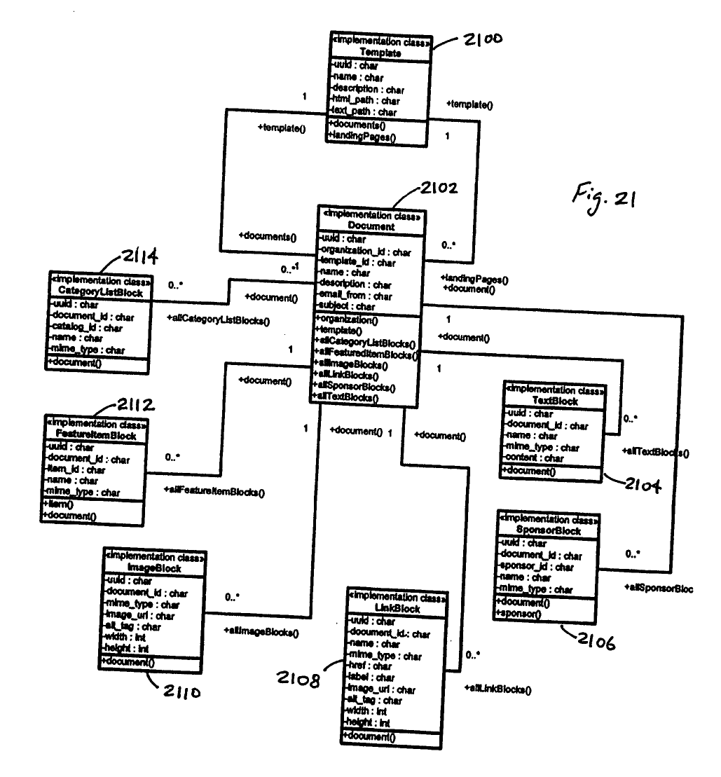

FIG. 22 illustrates an exemplary user interface 2200 presented by the catalog builder function that enables an auction committee member or other person authorized within an auction to combine auction items into a composite auction item utilizing the inventive techniques described herein. As shown in FIG. 22, the user may select pending donated items or items already published in a catalog for combination into a composite auction item. In FIG. 22, a user administrator specifies a name for the combined parent item and its description, followed by selecting a plurality of existing items to be combined. Next, the user administrator modifies the default properties and adjusts the data as needed. System 250 automatically combines selected properties, using any of summing, an aggregation or concatenation algorithms as applicable, for example descriptions, special notes, estimated value, etc., to be presented as default values that can be further edited as illustrated in the figure of 23. Exemplary items are listed in dialogue box 2206. Selected data fields within the parent record object, such as item name, lot number and category, may be user-defined through dialogue boxes 2202, 2204 and 2208, respectively, of interface 2200. Selection of the next page option from the user interface toy 200 of FIG. 22 causes an extension of user interface 2200 to be presented, as illustrated in FIG. 23. In FIG. 23, other data fields within the parent item record, such as description, on-line open date, on-line close date, estimated value, by now price, bid increments, opening bid, reserve price, etc., may be defined through the user-defined through dialogue boxes 2210, 2211, 2212 and 2213, 2214, 2216, 2218, 2220, and 2222, respectively, of interface 2200. Where applicable, the respective data values in the child item records are combined in the parent record, for example, as illustrated by description dialogue box 2210 in which the parent description comprises an aggregation of the descriptions of the component child items. Once the data within the parent item record is defined, it is saved and the appropriate methods within the component items will maintain the parent/child relationships to the parent item record. An catalog builder utility function which enables the process as outlined herein and in FIG. 11 and generates the interfaces of FIG. 22-23, may be part of the Platform tools server 402, the construction and function of which is within the scope of those recently skilled in the arts given the disclosure of the procedural algorithms and data structures and interfaces described herein, including the data type and methods of the relevant record objects.

FIG. 21 illustrates the relationship between template record 2100, document record 2102, text block record 2104, sponsor block record 2106, link block record 2108, image block record 2110, feature item block record 2112, and category list block record 2114. In the illustrated embodiment, template 2100 comprises the following variables:

uuid
name
description
html_path
text_path

The nature of the data type used to implement the variable in record 2100 is illustrated in FIG. 21. In template record 2100 the uuid is a unique universal identifier and may be implemented with a multiple bit field of alphanumeric data. The uuid data serves as a primary key to identify the template record. The name and description variables describe the name and nature of the template, respectively. The html_path and text_path variables describe resolvable addresses to memory location for html and text content, respectively, of the template.

In addition, the template record has at least a +documents( ) method which can be used to call up one more documents that have been created from the template record, using the appropriate documents identifier. A user customized document created following the selection of a template and population thereof with user-defined data is stored in one of the databases, as illustrated in FIG. 21.

In the illustrated embodiment, document record 2102, comprises the following variables:

uuid
organization_id
template_id
name
description
email_from
subject

The nature of the data type used to implement the variables in record 2102 is illustrated in FIG. 21. In document record 2102 the uuid is a unique universal identifier and may be implemented with a multiple bit field of alphanumeric data. The uuid data serves as a primary key to identify the document record. The name and description variables describe the name and nature of the document, respectively. The organization_id and template_id variables describe, respectively, the organization and template associated with the document. The email variable describes an electronic mail address associated with the document, typically that of the author or an auction administrator. The subject variable describes subject matter of the document. In addition, the document record has at least eight methods associated therewith to access one or more of any of the template record 2100, document record 2102, text block record 2104, sponsor block record 2106, link block record 2108, image block record 2110, feature item block record 2112 with which the document record is associated.

In the illustrated embodiment, text block record 2104 comprises the following variables:

uuid
document_id
name
mime_type
content

The nature of the data type used to implement each variable is illustrated in FIG. 21. In text block record 2104 the uuid is a unique universal identifier and may be implemented with a multiple bit field of alphanumeric data. The uuid data serves as a primary key to identify the text block record. The document_id variable identifies the document with which the text block is associated. The name variable describes the name of the text block. The mime_type variables describe message format associated with the text block while the content variables defines the content of the text block. In addition, the text block record has a +documents( ) method that can be used to call the document with which the text block record is associated.

In the illustrative embodiment, the web pages of an auction catalog or the homepage of the auction itself may have associated therewith one or more links to sponsors of the fundraising event. In the illustrated embodiment, sponsor block record 2106 comprises the following variables:

uuid
document_id
name
mime_type
content
sponsor_id

The nature of the data type used to implement each variable is illustrated in FIG. 21. In sponsor block record 2106 the uuid is a unique universal identifier and may be implemented with a multiple bit field of alphanumeric data. The uuid data serves as a primary key to identify the sponsor block record. The document_id variable identifies the document with which the sponsor block is associated. The name variable describes the name of the sponsor. The mime_type variables describe message format associated with the sponsor block while the sponsor_id variable identifies an optional sponsor associated with the document. In addition, the sponsor block record has at least +documents( ) and +sponsor( ) methods that can be used to call document and sponsor records, respectively, with which the sponsor block record is associated.

In FIG. 21, Link Block Record 2108 comprises the following variables:

uuid
document_id
name
mime_type
image_url
height
width
label
alt-tag
href

The nature of the data type used to implement each variable is illustrated in FIG. 21. In link block record 2108 the uuid is a unique universal identifier and may be implemented with a multiple bit field of alphanumeric data. The uuid data serves as a primary key to identify the link block record. The document_id variable identifies the document with which the link block is associated. The name variable describes the name of the link block. The mime_type variables describe message format associated with the link block while the image_url variable identifies the address of an optional image file associated with the link block record. The height, width, label, alt-tag, and href variables describe other characteristics associated with link image file associated with the link block record. In addition, the link block record has at least a +documents( ) method that can be used to call the document records with which the link block record is associated.

In the illustrative embodiment, image block record 2110 comprises the following variables:

uuid
document_id
mime_type
image_url
height
width
alt-tag

The nature of the data type used to implement each variable is illustrated in FIG. 21. In image block record 2110 the uuid is a unique universal identifier and may be implemented with a multiple bit field of alphanumeric data. The uuid data serves as a primary key to identify the image block record. The document_id variable identifies the document with which the image block is associated. The mime_type variables describe message format associated with the image block while the image_url variable identifies the address of an image file associated with the image block record. The height, width, and alt-tag, variables describe other characteristics of the image associated with the image block record. In addition, the image block record has at least a +documents( ) method that can be used to call the document record with which the image block record is associated.

In FIG. 21, feature item block record 2112 comprises the following variables:

uuid
document_id
mime_type
item_id
name

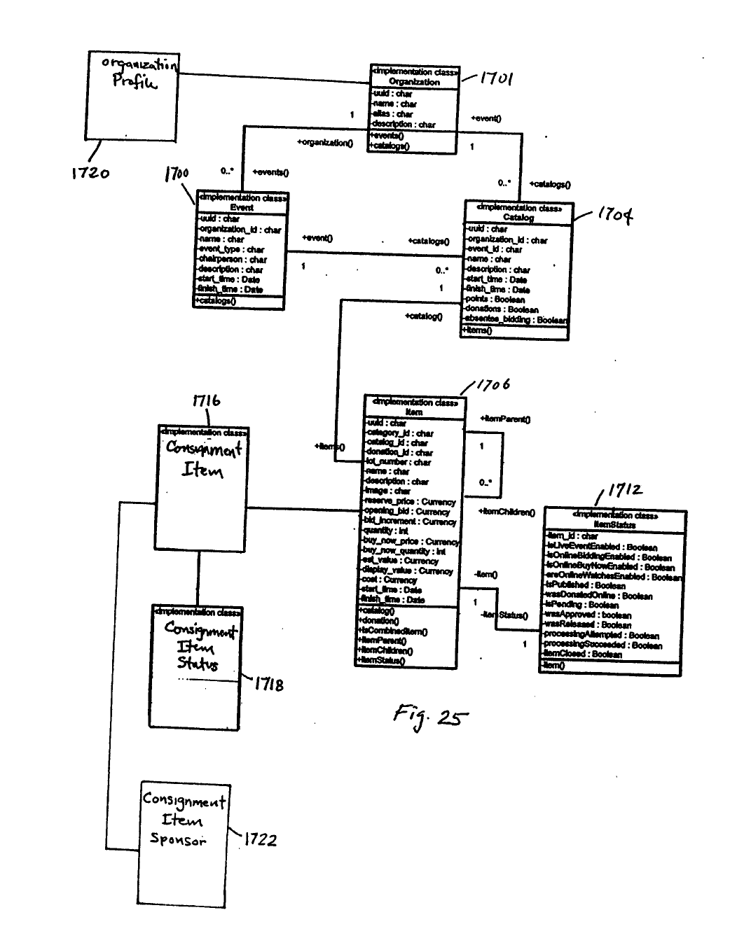

The nature of the data type used to implement each variable is illustrated in FIG. 21. In feature item block record 2112 the uuid is a unique universal identifier and may be implemented with a multiple bit field of alphanumeric data. The uuid data serves as a primary key to identify the feature item block record. The document_id variable identifies the document with which the feature item block is associated. The mime_type variables describe message format associated with the feature item block while the item_id variable identifies the featured item associated with the featured item block record. Typically, a featured item will be a catalog item donated by a sponsor and for which the sponsor wishes to be recognized. There may be multiple featured item blocks associated with a document. The name variable describes the name of the featured item. In addition, the feature item block record has at least the +documents( ) and +item( ) methods that can be used to call the document record and item record up, respectively, with which the feature item block record is associated. An example of a template for use with a sponsorship promotion including featured items is illustrated in FIG. 25.

In the illustrative embodiment, catalog list block record 2114 comprises the following variables:

uuid
document_id
mime_type
catalog_id
name

The nature of the data type used to implement each variable is illustrated in FIG. 21. In catalog lists block record 2114 the uuid is a unique universal identifier and may be implemented with a multiple bit field of alphanumeric data. The uuid data serves as a primary key to identify the catalog list block record. The document_id variable identifies the document with which the catalog list block is associated. The mime_type variables describe message format associated with the catalog list block while the catalog_id variable identifies the catalog associated with the catalog list block record. The name variable describes the name of the catalog. In addition, the catalog list block record has at least a +documents( ) method that can be used to call the document record with which the catalog list block record is associated.

Virtual Consignment Database

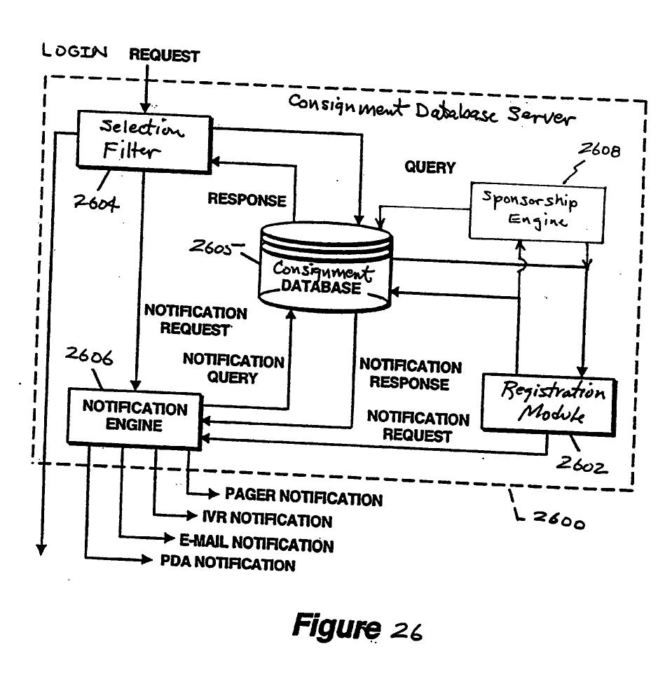

According to another aspect of the invention and as illustrated in FIG. 26, a consignment database server 2600 enables organizations to build catalogs using items made available from a consignment catalog for inclusion in an auction or raffle. In the illustrative embodiment, consignment database server 2600 comprises a selection filter 2604, a consignment database 2605, a registration module 2602, and a notification module 2606, all of which are logically interconnected, as illustrated. Consignment registration function module 2602 enables tracking of virtual consigned merchandise, including a inventory control function that monitors which items are referenced by which charitable organizations, auctions and catalogs.

Selection filter module 2604 associated with the consignment database allows a charitable organization (consignee) access to a set of items for which the organization qualifies according to their profile. An organization profile is used to determine which items can be selected from the consignment catalog, with high value items reserved for high profile events. The multi-faceted organization profile provides the input necessary to filter appropriate items within the consignment database 2605. The profile may be based on the organization's email list size, target revenue, catalog size, catalog value, etc.

Notification module 2606 interacts with notification selection filter 2604, database 2605, registration module 2602, and any of a paging server, Interactive Voice Response (IVR) server, SMTP mail module, or telephony serve, not shown. Alternatively, such for server functions may be implemented within notification module 2606 and the module interacting with the clients for the perspective notification types, also not shown.

As used herein, a ‘module’ includes, but is not limited to, software or hardware components which perform certain tasks. Thus, a module may include object-oriented software components, class components, procedures, subroutines, data structures, segments of program code, drivers, firmware, micro code, circuitry, data, data structures, tables, arrays, etc. In addition, those of ordinary skill in the art will recognize that a module can be implemented using a wide variety of different software and hardware techniques.

A set of user interfaces to selection filter module 2604, registration module 2602, notification module 2606 and consignment database server 2600 enable a client organization and vendor to manage the process of ordering, managing, selling, and reporting of items selected from the database, creating an online market or store that enables organizations to view and select available items based upon selection criteria from the organization and upon availability criteria from the vendor (consignor).

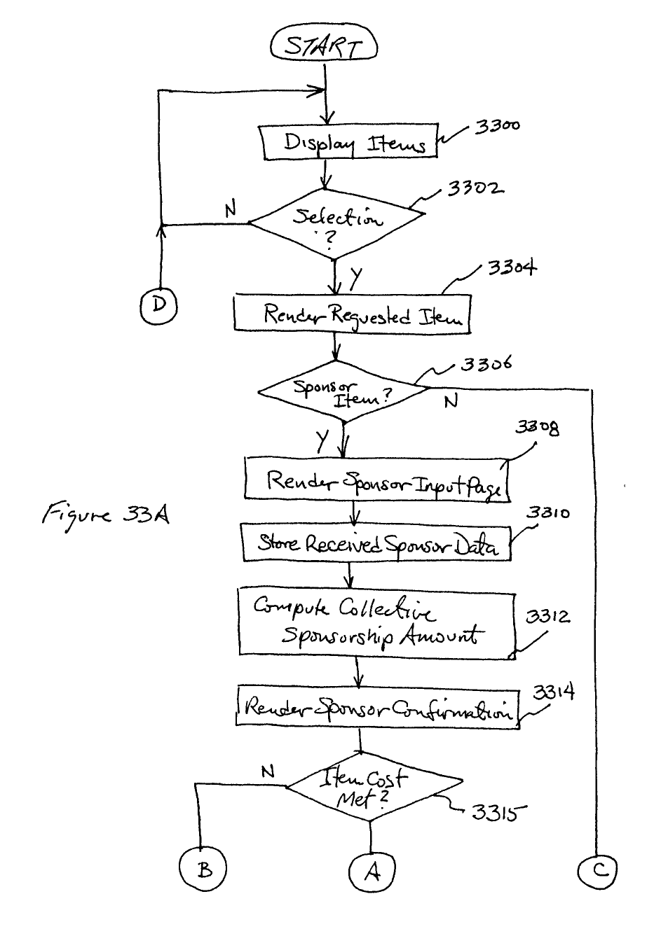

A sponsorship engine 2608, which may be implement it as its own stand-alone server as illustrated in FIG. 26, or, as a subcomponent of the consignment registration module 2602, enables prospective sponsors to sponsor or underwrite all or a portion of the cost of a consignment item, as described in greater detail with reference to FIG. 32-37 herein. As illustrated in FIG. 26, sponsorship engine 2608 communicates with both registration module 2602 and consignment database 2605. Sponsor engine 2608 may be employment implemented as a server application, collection of separately executable objects or modules, and hardware, or as a combination thereof, as would be understood by those reasonably skilled in the arts given the description contained herein.

### Data Structures/Record Data

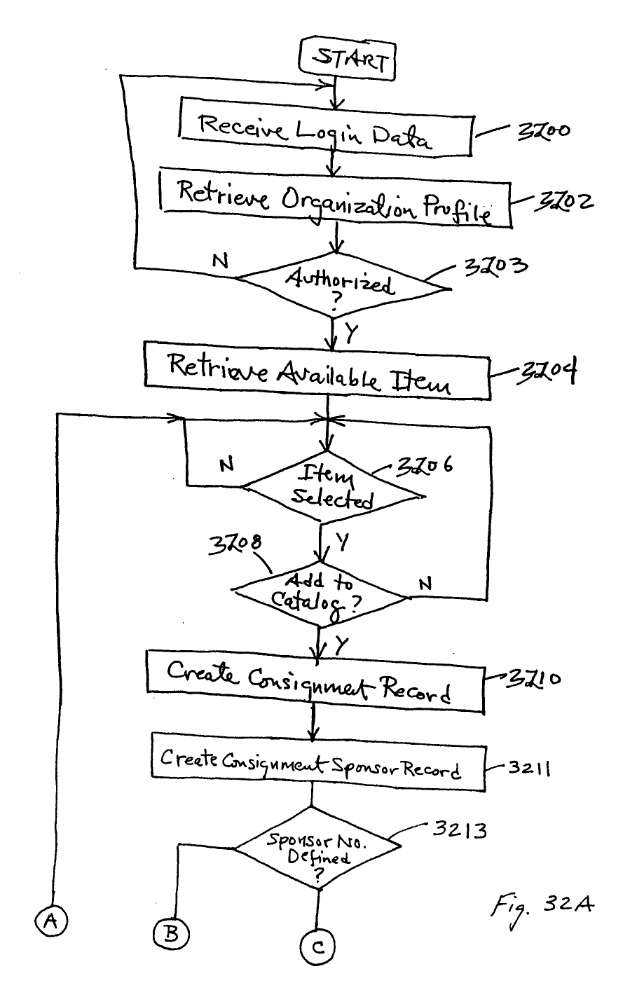

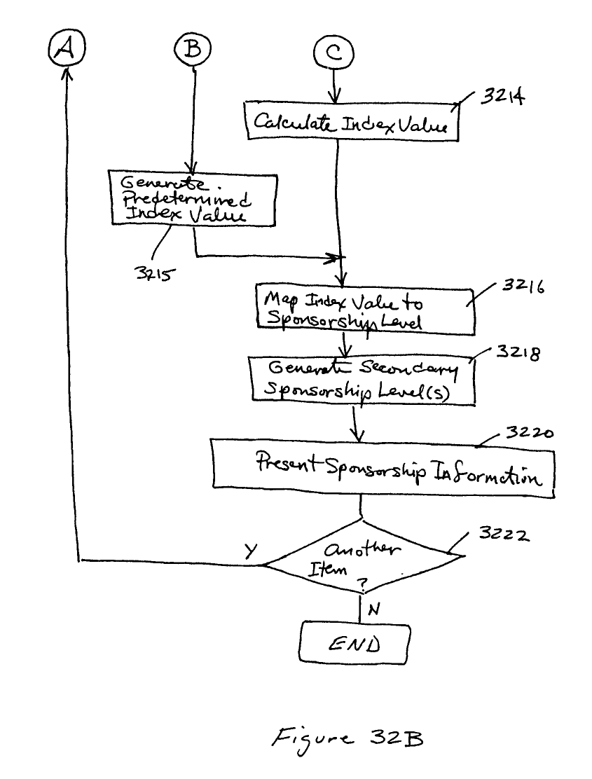

In the illustrative embodiment, the data structures processed by the inventive algorithms of FIG. 31 described herein are implemented in an object-oriented format with data records implemented as objects having both data and methods, as applicable. These record objects may be stored in any of the databases illustrated in the figures, including database 2605 of FIG. 26, and may include data which simultaneously resides as parts of other records in other databases. The data-types of the data variables contained within these records are similar to other data types described herein, e.g. char, date, Boolean, currency, etc., selected of which are explained in greater detail hereafter. In the illustrative embodiment, the data structure that identifies a selectable item within the consignment database 2605 is Consignment Item Record 1716

FIG. 25 illustrates the relationship between Organization Record 1701, Catalog Record 1704, Item Record 1706, Item Status Record 1712, Consignment Item Record 1716, Consignment Item Status Record 1718, Consignment Item Sponsorship Record 1722, and Organization Profile Record 1720. In the illustrated embodiment, Consignment Item Record 1716 may comprise any of the data fields described with reference to either Item Record 1706 or Item Record 1706A in addition to any of the following variables:

uuid
name
item cost
alias
description
image
special instructions
links (within description/special instructions)
limitations (blackout dates, etc.).
suggested opening bid
suggested bid increment
suggested reserve price
suggested ‘Buy It Now’ price
link and logo for vendor
link and logo for sponsor or marketing partner
quantity available
auction format (e.g. Dutch or Yankee)

Links within the description and/or special instructions data may be resolved to a supporting web site, for instance, as part of a travel package, a link to a hotel web site for further item information, etc. The Consignment Item Record 1716 may include +getConsignmentItemStatus( ) and +getConsignmentItem( ) methods to access the status record and the item information of the consigned item.

In the illustrated embodiment, a Consignment Item Sponsor Record 1722 exists for selected of the Consignment Item Record 1716. The Consignment Item Sponsor Record 1722 may comprise any of the data fields described with reference to Sponsor Block 2106 a FIG. 21 in addition to any of the following variables that may be useful to sponsorship engine 2608:

Item cost
Sponsor Number
Sponsor level 1
Sponsor level 1 range
Sponsor level N
.
.
.
Sponsor level N range
Cumulative Sponsorship Amount
Subscription Open
Sponsor ID List
image
Special instructions
Links (within description/special instructions)

In the illustrated embodiment, a Consignment Item Status Record 1718 exists for each item associated with a particular Consignment Item Record 1716 to maintain additional status and flags, as illustrated in FIG. 17. The Consignment Item Status Record 1718 may comprise any of the data fields described with reference to either Item Status Record 1712 in addition to any of the following variables that may be useful to Notification module 2606:

email address
phone number
mobile phone number
fax number

### The Consignment Item Status Record 1718 may include +getConsignmentItem( ) method to access the item information of the consigned item.

In the contemplated embodiment, consignor vendor organizations may utilize criteria to limit the organizations that can view and select their items from database 2605. Such criteria may include one or more the following:
only display items to organizations that fall within a geographic area
only display items to organizations based upon affiliation (i.e., only display items to Cystic Fibrosis chapters)
only display items to organizations that meet other demographic or size criteria
only display items to organizations that will allow marketing messages from the vendor to their constituency
only display items to organizations willing to accept marketing links and logos:
   embedded in the catalog
   under items
   within emails
   on the home page
   as part of a home page template

Selection filter 2604 associated with the consignment server 2600 allows a charitable organization access to a set of items within database 2605 for which the organization qualifies according to their profile. An organization profile, which may be implemented as part of client record 1720, described previously, is used to determine which items can be selected from the consignment database (catalog) 2605. In the illustrated embodiment, Organization Profile Record 1720 may comprise any of the data fields described with reference to either Organization Record 1706 or Organization Record 1706A in addition to any of the following variables:

uuid
organization_id
event_id
name
email list size
target revenue
catalog size
catalog value

The Organization Profile Record 1720 may include +getOrganizationRecord( ) method to access the information of the charitable organization. The multi-faceted organization profile provides the input necessary to filter appropriate items within the consignment database 2605. A typical filtering criteria would be to reserve high value items for high profile events/clients.

Catalog Interface

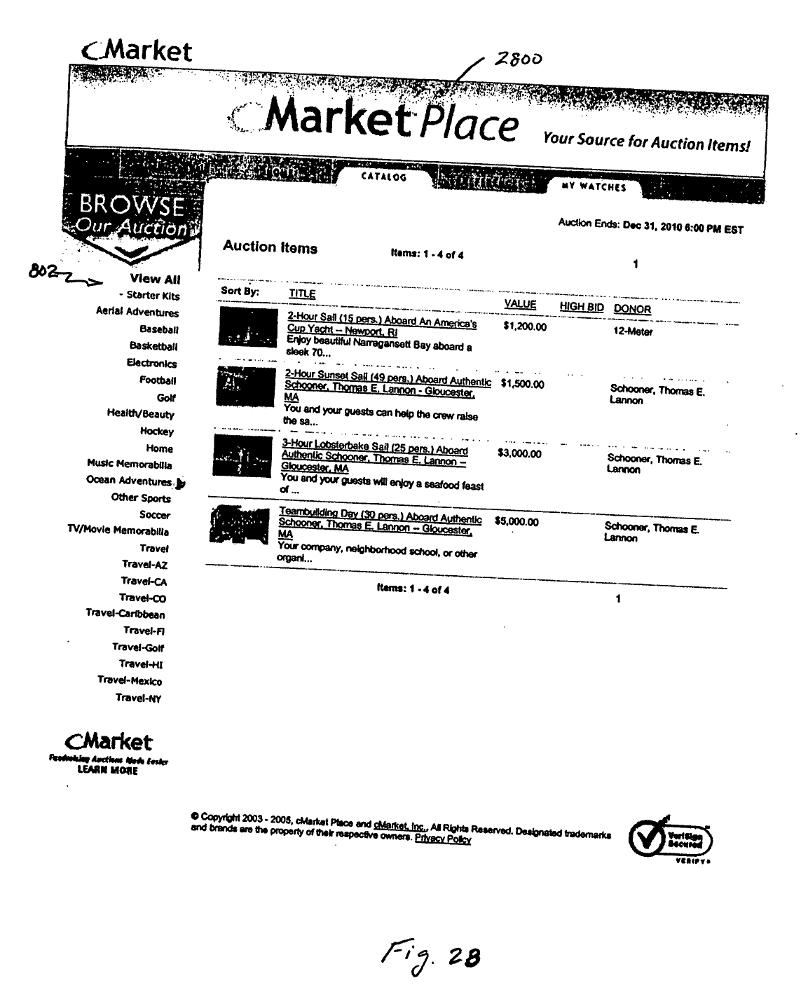

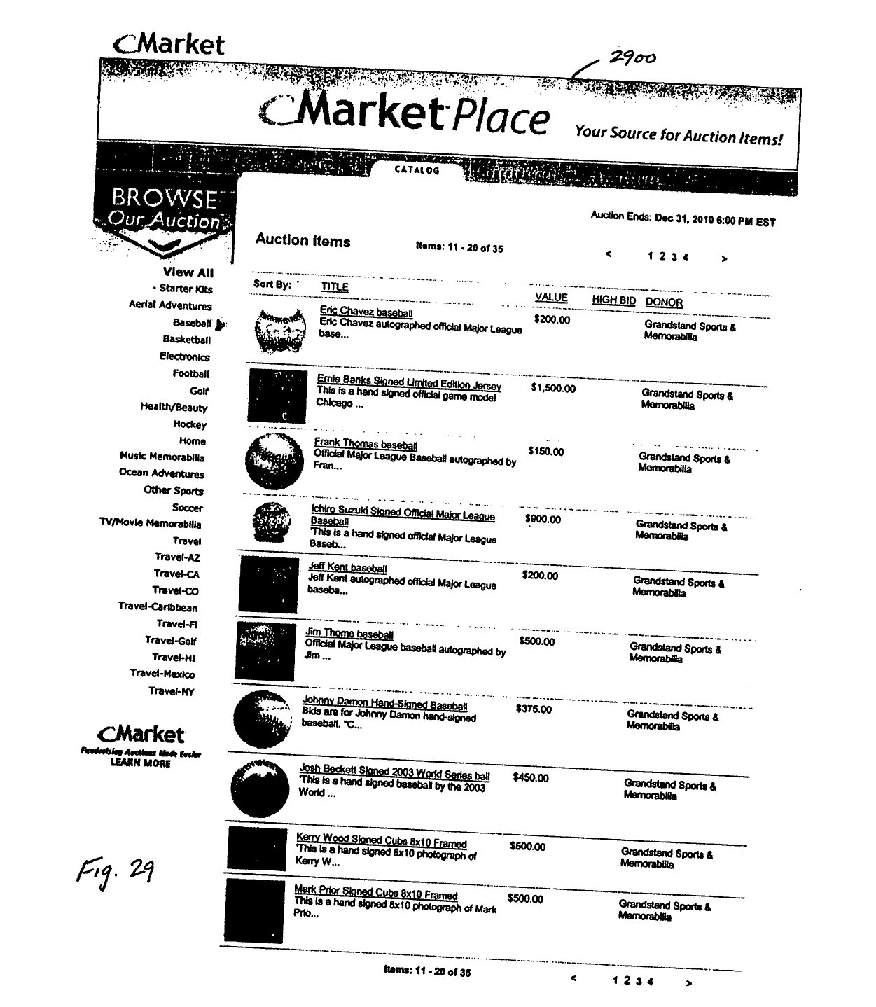

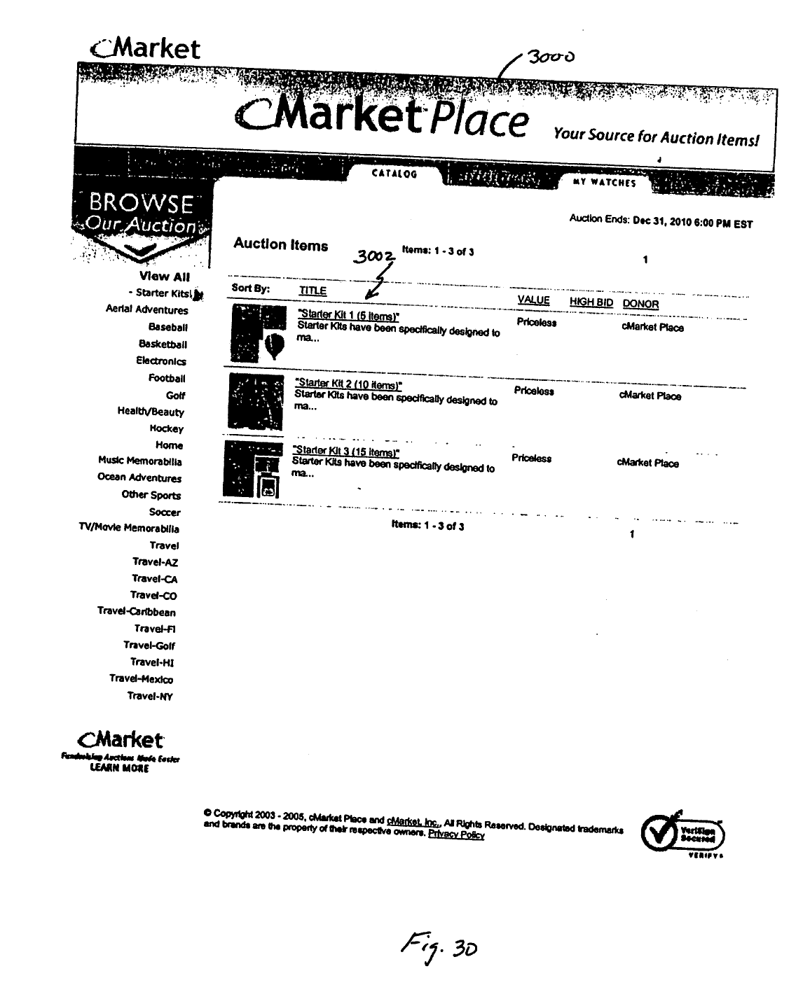

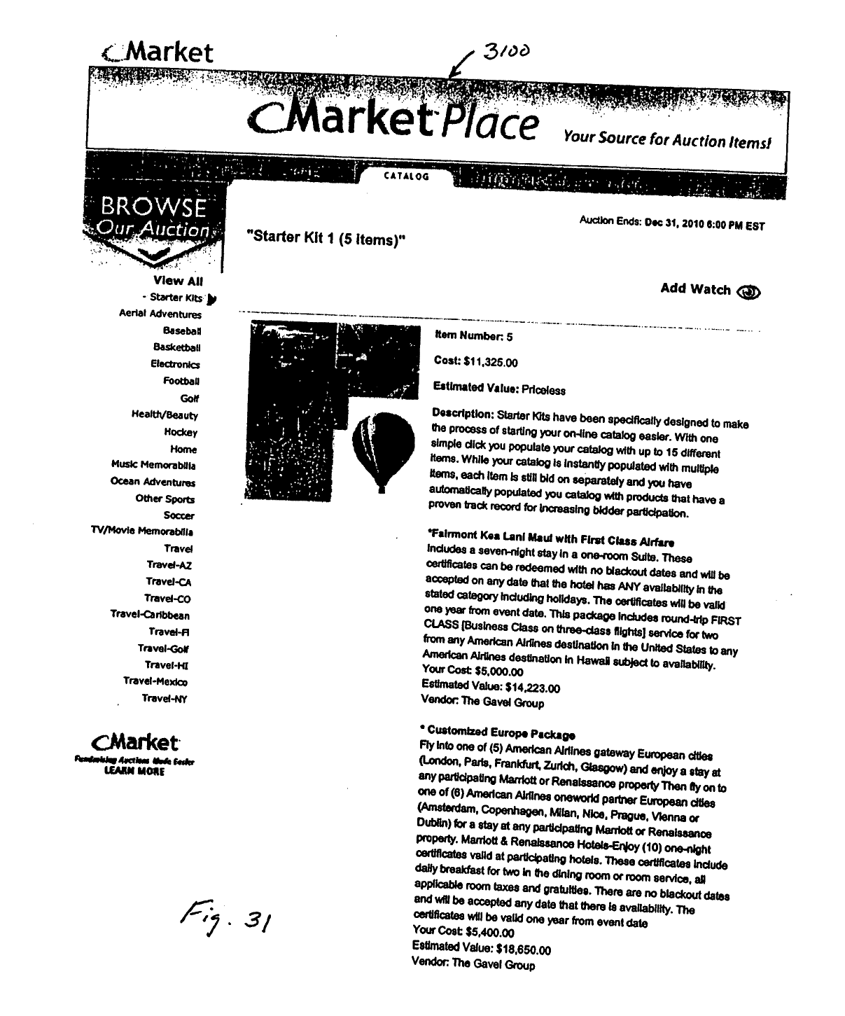

FIGS. 28-31 illustrate conceptually the graphic user interface(s) of web pages 2800, 2900 3000, and 3100, respectively, that a charitable client may utilize to create a catalog of items for an auction event, in accordance with the inventive system. These web page interfaces enable the charitable client user to browse consignment database and to selectively add catalog items, as desired. In FIG. 28, the charitable client user, who is typically a member of an auction committee for the nonprofit organization or charity, designates which category 2802 of available items is to be viewed. A category of items may be a collection of items with some commonality, for instance, travel items or trips to Hawaii, etc. A packages of items may be a collection of items that may be grouped according to a theme or by other criteria. It is also contemplated that items can be listed in multiple categories, for instance, a trip to Hawaii may be listed in ‘Hawaii Travel’, ‘United States Travel’, and/or ‘Exotic Locations Travel.’ Specifically, FIG. 28 illustrates web page 2800 displaying various available items under the general category of ocean adventures. FIG. 29 illustrates web page 2900 displaying various available items under the general category of baseball. FIG. 30 illustrates web page 3000 displaying various available items that are each starter packages of items. Selection of the first package 3002, will cause web page 3100 to be displayed which includes a description on the various elements within the package as well as the combined value of the items within the package.

When a committee member approves a consigned item an automatic electronic mail notification is sent to the vendor and host service. Upon selection, the consigned item is added to the auction database and published to a database-server auction catalog based upon the ‘born on’ date or, if a ‘born on’ date is not present, the item may be published immediately. Vendors can view a ‘personal page’ that lists the items that they have on consignment and their current status in various auction processes, including the current bid status. Such personal page may be similar to that illustrated in FIG. 24 herein. When an item is sold an automatic electronic mail may be generated and sent to the Vendor using the notification engine described hereafter.

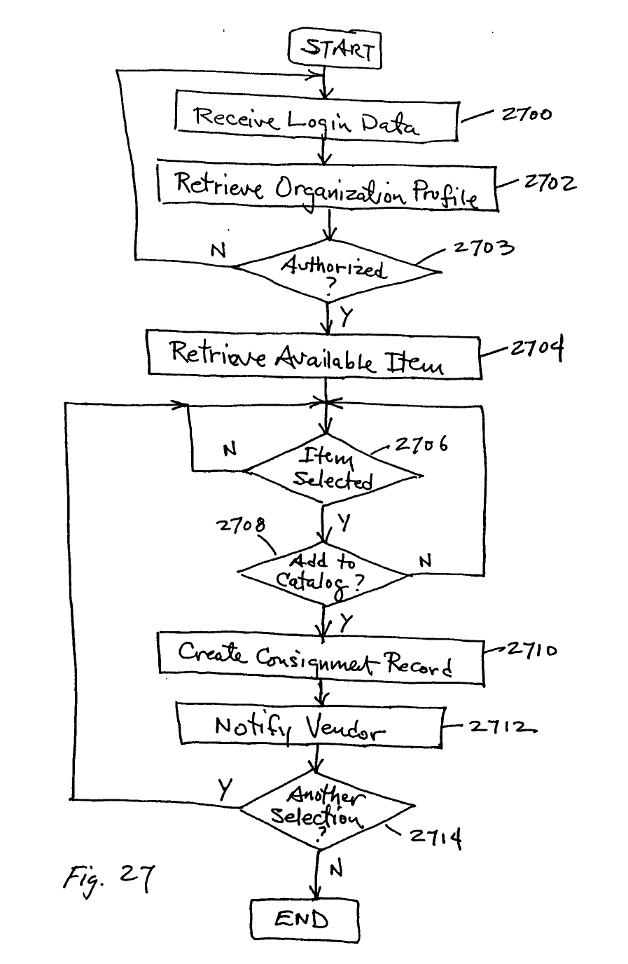

Utilizing the records and data types, illustrated in FIG. 25 and elsewhere herein, and the physical and logical infrastructure, illustrated in FIG. 26 and elsewhere herein, the process utilized by an organization, typically an authorized member or administrator of the auction committee for the charitable organization, to build a catalog from items within the consignment database is illustrated in FIG. 27. The charitable client accesses the web page presented by consignment database server 2600 for managing consigned item, as illustrated by process block 2700. Upon identification of the charitable organization, typically through receipt of an account ID and password, selection filter module 2604 retrieves the organization profile record, as illustrated by decisional block 2702, and checks to authenticate the user based on the their previously submitted organization profile, as explained herein, as illustrated by decisional block 2703. If authorized, selection filter module 2604 searches the records of pending items within database 2605 and determines which consignable items are accessible to the authenticated charitable organization, as illustrated by process block 2704. A web page containing selectable categories, similar to those illustrated in any of FIGS. 28-30, is presented as illustrated by process block 2704. Using FIG. 28 for exemplary purposes only, the user designates which category 2802 of available items is to be viewed. The user may then select any of the displayed items for review, as illustrated by process block 2706, and, if desired, add the consignment item to the current charitable organization catalog through selection of the appropriate tab, as illustrated by process block 2708. When a consignment item is selected for inclusion in the catalog of a charitable organization a new Consignment Item Record 1716 is instantiated and populated with the relevant data by registration module 2602, as illustrated by process block 2710, and a notification requests with the relevant data sent to notification module 2606 for alerting the vendor or other interested party, as illustrated by process block 2712. if another item is to be added to the organization catalog, the process represented by blocks 2706 through 2712 may be repeated as applicable. Once the user process representing an authorized auction administrator has finished selecting consignment item(s) or at the time of actual selection, the item(s) are submitted to the appropriate catalog for publication, as previously described. In this manner, the catalog for the auction event may comprise items submitted through constituency via the previously described approval process, as well as item selected from the consignment database.

Notification module 2606 initiates a notification process to alert the vendor, a host service provider or other interested party. This function is provided through Notification module 2602 that utilizes a configurable notification methodology that can map closely an organization's specific needs and requirements. Such module may incorporate rules- and policy-based case notification by individual, role, or group, and includes additional customizability based on notification type. Supported notification mechanisms may include various terminal types supporting the receipt of standard protocol text messaging or e-mail, including personal computer, text pager, wireless Personal Digital Assistant (PDA), and mobile phones with messaging capability. The e-mail or text message may contain any of the record data listed herein regarding the consigned item and organization, per the notification content format established during system configuration.

In the illustrative embodiment, a notification module 2606 associated with the consignment database 2605 may include functionality for any of email, telephone, fax and/or other communication methods, that informs a vendor: 1) when an item has been ordered; 2) enables a vendor to approve an item for inclusion in an auction or raffle; 3) informs the vendor of the organization characteristics, including type, location, email list size, other pertinent information; and 4) informs the vendor when an item has been sold and at what cost. The same or a separate notification engine system may similarly include any of email, telephone, fax and/or other communication methods, that informs a host service provider: 1) when an item has been ordered; 2) when an item has been approved; 3) when an item has been sold, including the quantity of item(s), item cost, margin and final sale price.

The above described virtual consignment functionality of the inventive system is intended for charitable organizations that are registered with the host system and utilize the other aspects of the host system including an on-line auction, however, such functionality may also be extended to any nonprofit charitable organization running an auction or raffle, whether or not conducting an on-line auction, to access, select, and sell items on a consigned basis within their auction. In such alternative implementation, a charitable organization can select items from the virtual consignment database on a completely ‘open’ basis with where organization only provides information after selecting an item or on a limited basis that requires organizations to register and provide organizational information prior to item selection. The registration process may require, as applicable, an organization to agree to a licensing agreement. Items selected are approved by supplying company, that is, when an item is selected the supplier is notified about the organization (contact information, organizational information, auction information) and the selected item is ‘made available’ to the organization. Once an item is ‘available’ the organization can: 1) print an item data sheet, 2) download a text file, and is a Microsoft Word document, with the item information, picture, etc., for incorporation into a catalog, 3) download an image file, such as a .PDF document with the same information as the Word document, and allow access to ‘close-out’ portion of above described system and to complete item purchase transactions.

Although the above embodiment has been described with reference to items that are available from vendors or third parties via consignment, it will be obvious to those recently skilled in the arts that items may be similarly available through the same system gratis or free of charge, or for purchase at time of selection.

Donor Sponsorship of Consignable Items

In an alternative embodiment, event items are consigned by the charitable organization at the time of selection, utilizing the physical and logical infrastructure and techniques described herein in conjunction with the various record data for the organization profile and the vendor items, or, alternatively, may be wholly or partially purchased or underwritten either prior to or during the actual fundraising event through participating sponsors, as described herein.

The processes and techniques for sponsorship of a charitable auction described previously herein are well suited for businesses and corporations. However, the disclosed systems may also facilitate lower levels of sponsorship by private individuals as well. Specifically, an individual who is neither interested in bidding on any of the auction items in a published catalog, or donating an auction item, may contribute all or a predefined portion of the costs of one or more consignable item available in the consignment database described previously. In this manner, one or more donors may collectively purchase (sponsor or underwrite) a consignable item for the charitable entity allowing the entity to benefit from the full winning bid price of the auction item, without having to pay the vendor for the cost of value of the consignable item from the winning bid proceeds.

Utilizing the records and data types, illustrated in FIG. 25 and elsewhere herein, and the physical and logical infrastructure, illustrated in FIG. 26 and elsewhere herein, the process utilized by an organization, typically an authorized member or administrator of the auction committee for the charitable organization, to select items for consignment is illustrated in FIGS. 32A-B. The charitable client accesses the web page presented by consignment database server 2600 for managing consigned item, as illustrated by process block 3200. Upon identification of the charitable organization, typically through receipt of an account ID and password, selection filter module 2604 retrieves the organization profile record, as illustrated by decisional block 3202, and checks to authenticate the user based on the their previously submitted organization profile, as explained herein, as illustrated by decisional block 3203. If authorized, selection filter module 2604 searches the records of pending items within database 2605 and determines which consignable items are accessible to the authenticated charitable organization, as illustrated by process block 3204. A web page containing selectable categories, similar to those illustrated in any of FIGS. 28-30, is presented as illustrated by process block 3204. Using FIG. 28 for exemplary purposes only, the user designates which category 2802 of available items is to be viewed. The user may then select any of the displayed items for review, as illustrated by process block 3206, and, if desired, add the consignment item to the current charitable organization catalog through selection of the appropriate tab, as illustrated by process block 3208. When a consignment item is selected for inclusion in the catalog of a charitable organization a new Consignment Item Record 1716 is instantiated and populated with the relevant data by registration module 2602, as illustrated by process block 3210. A new Consignment Item Sponsor Record 1722 is instantiated and populated with the relevant data by sponsorship engine 2608, including retrieving the Item Cost value from record 1716 or directly from consignment database 2605, as illustrated by process block 3211. Note that the activity of instantiating and populating a new Consignment Item Sponsor Record 1722 occurs in addition to or in place of any vendor notification designated by process block 2712 of the FIG. 27 (not shown).

The sponsorship levels associated with any particular consignment item is determined algorithmically by sponsorship engine 2608 solely or in conjunction with user-defined input. Upon selection of an item for consignment, the charitable client user is provided with a dialog box or other user interface input mechanism to define a Sponsor Number value representing the number of desired sponsors for a selected consignment item, as illustrated by decisional block 3213. Such user interface input mechanism may be implemented as part of the web page presented by consignment database server 2600 for managing consigned item or as its own separate webpage. FIG. 32B is a flowchart of the algorithmic processes by which sponsorship engine 2608 determines the sponsorship ranges for a particular item within the consignment database 2605. If the Sponsor Number value was defined in decisional block 3213, sponsorship engine 2608 calculates an interim index value by dividing the Item Cost value by the Sponsor Number value, as illustrated by process block 3214. The resulting index value is compared to a plurality of predetermined Sponsorship Levels (ranges) stored in memory associated with sponsorship engine 2608, to determine into which of the ranges the index value falls between the range minimum and maximum range values, as illustrated by process block 3216. As will be described in greater detail with reference to the user interface of webpage 3400, a plurality of sponsorship ranges may be offered to perspective sponsors. For example, sponsorship ranges 3410-3414 of webpage 3400 may have the following values:

Sponsorship Range 1: $20-$100

Sponsorship Range 2: $100-$500

Sponsorship Range 3: $500-$2000

If in decisional block 3213, the Sponsor Number value is not defined by the user, a predetermined index value may be generated by sponsorship engine 2608, as illustrated by procedural block 3215. Such predetermined index value, in one embodiment, is dependent on the Item Cost value in the Consignment Item 1716 record, with higher costs items having larger predetermined index values. For example, an item having an Item cost value of $500 may have a predetermined index value of $100 while another item having a Item cost value of only $300 may have a predetermined index value of $60. Typically, in the predetermined index value is a fractional percentage of the item cost value. Such predetermined value/item cost tuples may be stored in memory associated with sponsorship engine 2608 in a lookup table or other format. A predetermined index value is then utilized by sponsorship engine 2608 to identify one of a plurality of predetermined the Sponsorship Levels, as similarly described with reference to process blocks 3216. On The Sponsorship Level identified in process block 3216 may have links to other associated ranges which may be either overlapping or progressively contiguous in either increasing or decreasing value. Sponsorship engine 2608 stores in record 1722 the calculated sponsorship values or ranges as Sponsorship Level-N depending on the number required, as illustrated by process blocks 3218. Sets of predetermined ranges, as well as the relationship between ranges, may have optimal empirically derived values. Typically, the highest Sponsorship Level may include a maximum value which represents the full Item Cost, while the lower Sponsorship Ranges may have a values which represents fractional percentages of the Item Cost.

It will be obvious to those recently skilled in the arts that are numerous modifications to the algorithm used for suggesting either in discreet sponsorship values are ranges of values may be created utilizing the description contained here in without departing from the spirit and scope of the disclosed system. In an alternative embodiment to the above process.

In another alternative embodiment, discreet sponsorship values may be calculated as the product of the index value computed in process block 3214 and whole number multiples up to the Sponsor Number value. For example, if the computed index has a value of $50 and the Sponsor Number value has a value of 4, multiplying the computed the index by integer values from 1 to the Sponsor Number value, results in a plurality of discreet sponsorship values of $50, $100, $150, and $200. As a further alternative embodiment, again, if the Sponsor Number value is not defined by the user, a predetermined value may be utilized which is dependent on the Item Cost value in the Consignment Item 1716 record, with higher costs items having larger predetermined values. Such predefined value may then be used as the computed index value in process block 3214.

Returning again to FIG. 32B, once all of the data relating to a sponsored item is calculated, including the Sponsorship Levels, the data is presented, typically in a webpage format, to the auction administrator, as illustrated by process block 3220. Optionally, a dialog box or other input mechanism may be provided within a webpage which enables the authorized auction administrator to override the Sponsorship Levels or ranges calculated by sponsorship engine 2608 and enter user-defined values. Such option may be appropriate for special one-of-a-kind items or items of unusual value. Thereafter, if another sponsorable item is to be added to the organization catalog, as illustrated by decisional block 3222, the process represented by blocks 3206 through 3218 is repeated as applicable. Once the user process representing an authorized auction administrator has finished selecting consignment item(s), the item(s) are submitted to the appropriate catalog for publication, as previously described. In this manner, the catalog for the auction event may comprise items selected from the consignment database, selected of which may be sponsored to defray the costs to the charitable organization.

Note that although the process for selecting consignable items for sponsorship is described above as occurring simultaneously with the process of selecting items from the consignment database 2605, such process may be performed subsequently thereto, including once one or more consignable items have been selected for inclusion in a virtual catalog associated with an auction event, or, even after a particular consignable item is published and in the live auction process. The functional processes performed by sponsorship engine 2608 in such instances are a subset of those described previously, as would be understood by those recently skilled in the art in light of the disclosure herein.

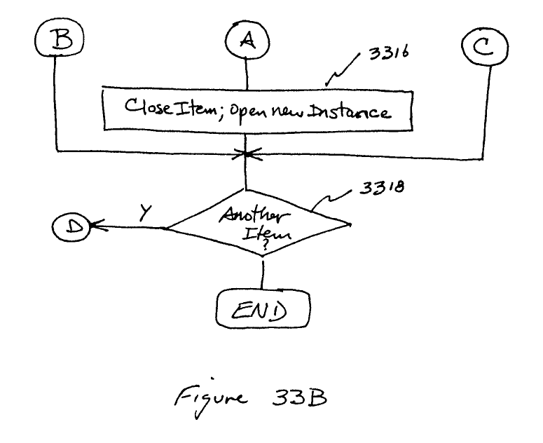

Once all items to be sponsored have been selected from the consignment database and the appropriate sponsor ship levels or ranges defined, a series of one of more web pages are generated by the sponsorship engine 2608 either prior to or as part of a live auction event. FIG. 33 is a flowchart of the algorithmic processes by which sponsorship engine 2608 displays, receives user-defined data and modifies the status of sponsorable items. FIGS. 34-37 illustrate conceptually the graphic user interface(s) of web pages 3400, 3500 3600, and 3700, respectively, generated by sponsorship engine 2608 and usable by a perspective sponsor to sponsor one of selected catalog of items in an auction event, in accordance with the inventive system. These web page interfaces enable the perspective sponsor to browse either consignment database or a virtual catalog associated with a fund-raising event and to underwrite items, as desired.

FIG. 34 illustrates conceptually a Sponsor Item Page 3400 which enables a user to browse sponsorable consignment items 3402-3408 from the virtual catalog associated with the auction event, or, directly from the consignment database 2605. Such activity may occur either prior to or during the auction event. As illustrated in FIG. 34, each of consignment items 3402-3408 may be associated with each of sponsorship levels 3410-3414. Sponsorship levels 3410-3414 may have different or over lapping ranges of donations. The sponsorship ranges illustrated in FIG. 34 are for exemplary purposes only and are not to be considered limiting. Web page for 3400 further comprises a graphic element, such as a selectable button 3416 which may be persistent through all web pages in a virtual catalog and which enables the perspective sponsor to access web page 3400.

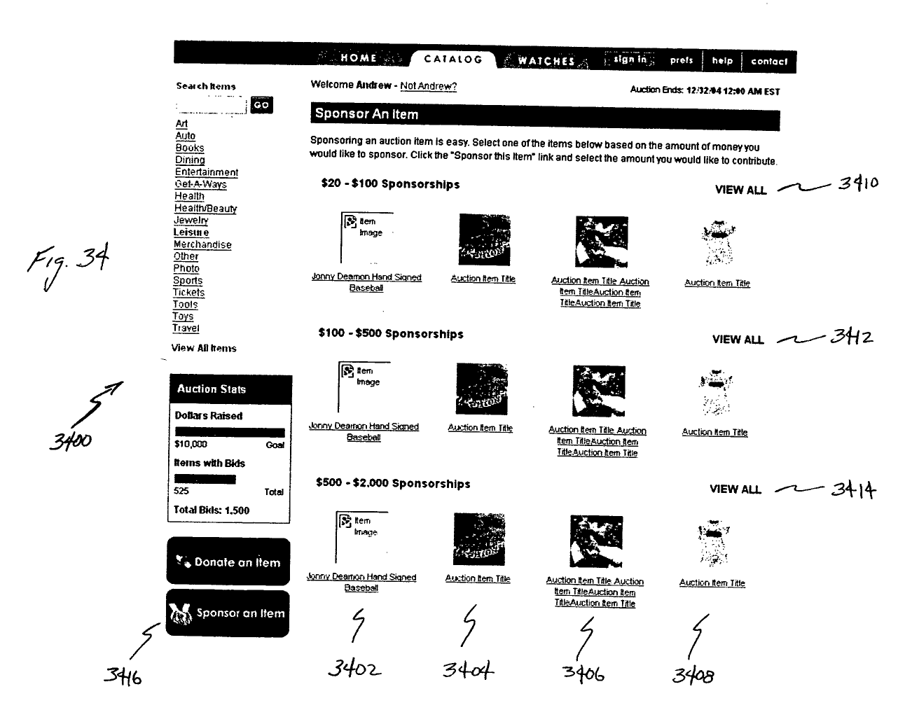

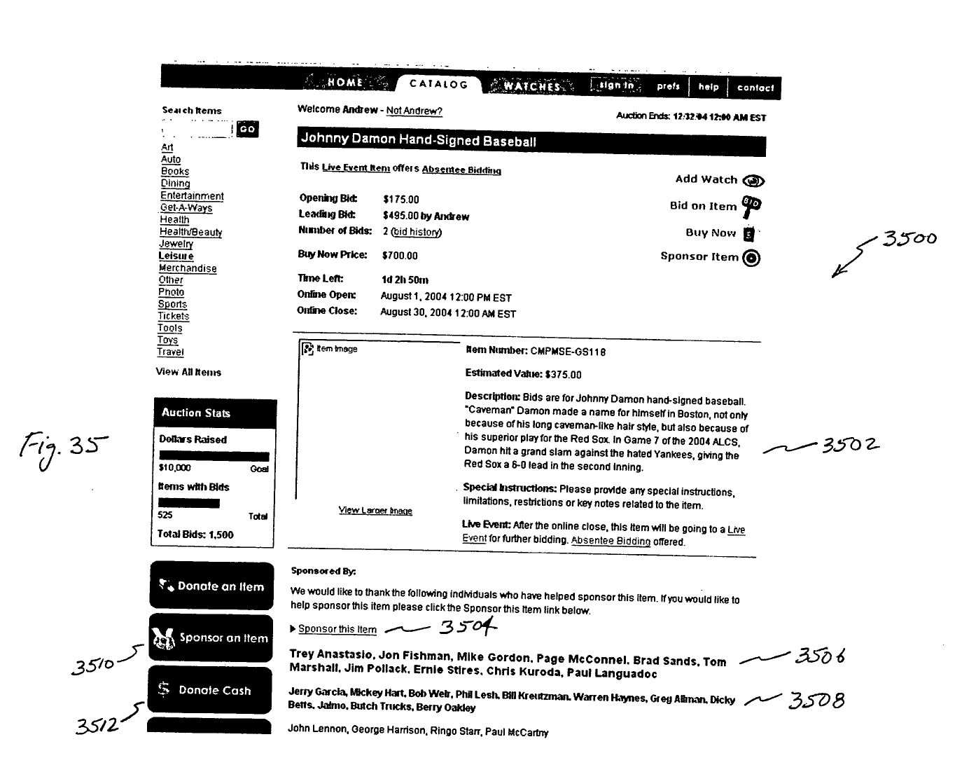

FIG. 35 illustrates an Item Accepting Sponsorship web page 3500 which is accessible from page 3400 by selection of one of the consignment items 3402-3408. When page 3500 comprises a section 3502 containing information specific to the consigned item, a link 3504 to a Sponsor Item Form 3600, and sponsor information section 3506, which, in the illustrative embodiment, is a simple list of the names of sponsors of this particular consignment item. In addition, when page 3500 also includes a graphic button 3510 similar in function to button 3416 of webpage 3400.

Sponsor sponsorship engine 2608 computes and compares the total of received sponsorship dollars with the cost of the consignment item, and either closes sponsorships once the price has been reached or instantiate a new similar consignment item. Optionally, the level of a sponsor donation defines the visibility of a sponsorship attribution associated with the item.

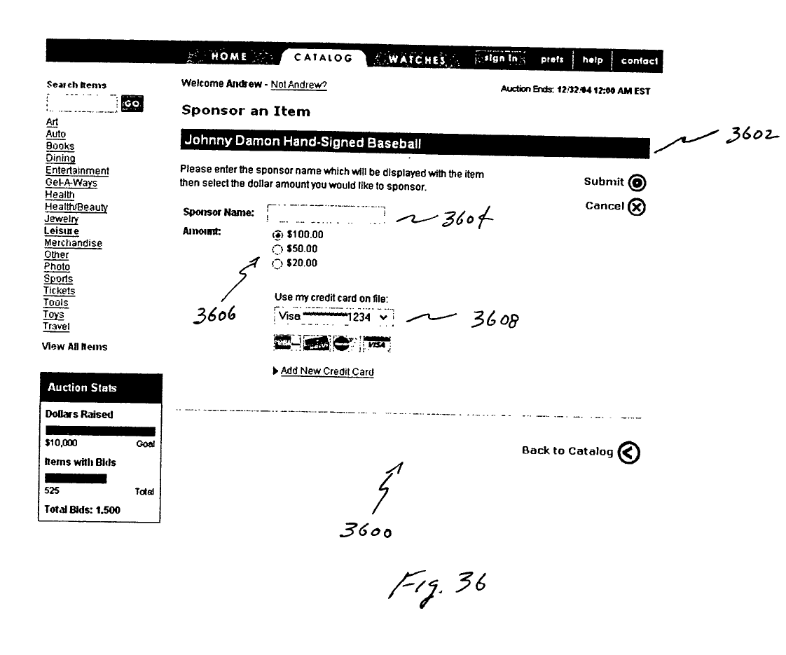

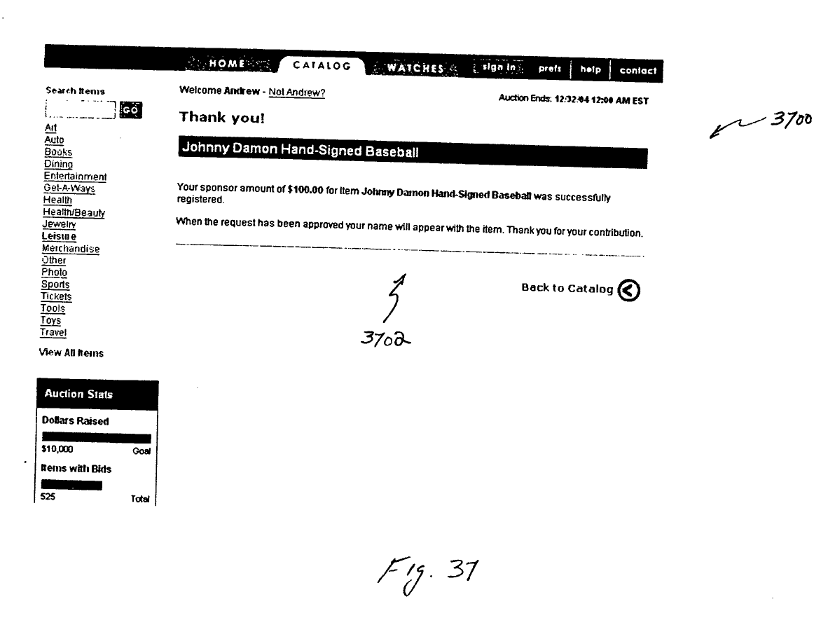

FIG. 36 illustrates conceptually a Sponsor Item Form 3600 comprising a section 3602 including dialog boxes 3604-3608 which enable a user to enter sponsor name, sponsor amount, and credit card information. FIG. 37 illustrates conceptually a Sponsor Request Confirmation Page 3700 that includes a section 3702 in which the sponsorship information is confirmed, including the sponsorship amount and the item, as illustrated.

The process by which a perspective sponsor interacts with sponsorship engine 2608 is described herein with reference to the flowchart of FIGS. 33A-B. A perspective sponsor browses, as part of a live auction or before the live auction begins, a virtual catalog associated with an auction event. Each virtual catalog page has a button, similar to button 3416, which, upon selection thereof, causes sponsorship engine 2608 to render web page 3400, as illustrated by process block 3300. Selection of one of the consignment items 3402-3408, as illustrated by decision block 3302, initiates the sponsorship process causing sponsorship engine 2608 to retrieve the information from record 1722 associated with the selected item and render webpage 3500, as illustrated by process block 3204. If after reviewing the information contained in any of sections 3502, 3506 and 3508 the user selects link 3504, sponsorship engine 2608 will render webpage 3600, as illustrated by decision block 3306 and process block 3308. The data entered by the prospective sponsor is stored by sponsorship engine 2608 in the appropriate record 1722, as illustrated by process block 3310, and the value specified by the prospective sponsor is added to Cumulative Sponsorship Amount, as illustrated by process block 3312, and generates web page 3700 which confirms sponsorship of the item by the designated amount, as illustrated by process block 3314. He sponsorship information, the name of the sponsor is supplied, it is also added to section 3506 of web page 3500. The Cumulative Sponsorship Amount represents the cumulative amount of all sponsorship donations towards that instance of the item up to that point. Next sponsorship engine 2608 compares the Cumulative Sponsorship Amount to the Item Cost, and, if the Item Cost has been reached or exceeded, the subscription to that instance of the item is closed and, optionally, if available, a new instance of the item is opened using a similar record data for the prior item, as illustrated by process block 3316. Otherwise, sponsorship engine 2608 returns control to webpage 3400 for possible selection of another item to be sponsored, as indicated by decision block 3318.

Although the sponsorship information in the illustrative embodiment described above is limited to the name of the sponsor, it will be obvious to those recently skilled in the arts that other sponsorship information may be included, including any of the sponsorship information and formats previously described herein.

In the illustrative embodiment, items sponsored by the same member can span catalogs and organizations for any particular member. A sponsor page, similar in construction and function to FIG. 24 described herein, provides a single view across all catalogs to view sponsored items. On the member's sponsor page, sponsored items are grouped together within their relevant catalog. Sponsors can view a the list of items they have sponsored, the per item sponsorship value, the cumulative sponsorship of value across all items, and the current bid status of any particular item during the auction process. Upon request of the sponsor, and utilizing the record objects and methods described herein, including, but not limited to those of FIGS. 17-20, a set of queries are made into the respective databases, as would be understood by those reasonably skilled in the arts, given the descriptions contained herein. The resulting data is then assembled as a Web page which can be displayed by the sponsor member. Other optional links on the Web page may provide additional information. Note that the sponsor page may include any relevant image files related to the respective items from the image server. The inventive system further maintains relationships among various items that enable searching capabilities such as to allow catalog viewers to sort the catalog by ‘sponsored for’, to enable sponsors to forward, via electronic mail, the catalog listing of their items.

The reader will appreciate that the inventive system of the present invention provides the tools and facilities for a nonprofit or charitable institution to create either a live or virtual auction event, compile lists of potential donor/bidder participants, create a catalog from donated items, combine individual donated items into aggregate item offerings, and facilitate on line viewing in bidding of the published catalog items in a manner that is efficient and capable of reaching the vast potential of the virtual online community for a particular cause.

Although the inventive concepts disclosed herein have been described with reference to implementations regarding auctions for nonprofit or charitable entities, the inventive concepts may equally apply to commercial or any other auction in which it is a desirable to combine multiple auction items. For example, in commercial auctions, the donor may correspond to a seller or seller(s) while the charitable entity, as well as the persons authorized to edit the auction items, may be from the same or separate business entities, such as auction hosting services, auction houses, or other online services.

Although the inventive concepts disclosed herein have been described with reference to implementations in an object-oriented environment, other programming techniques utilizing other data structures and memory configurations may be similarly utilized to achieve the same results as the inventive system described herein. For example, the record structures may be implemented other than as objects and the described databases may be implemented in different configurations, redundant, distributed, etc., while still achieving the same results.

The above-described invention may be implemented in either all software, all hardware, or a combination of hardware and software, including program code stored in firmware format to support dedicated hardware. A software implementation of the above described embodiment(s) may comprise a series of computer instructions either fixed on a tangible medium, such as a computer readable media, e.g. diskette 142, CD-ROM 147, ROM 115, or fixed disk 152 of FIG. 1, or transmittable to a computer system in a carrier wave, via a modem or other interface device, such as communications adapter 190 connected to the network 195 over a medium 191. Medium 191 can be either a tangible medium, including but not limited to optical or analog communications lines, or may be implemented with wireless techniques, including but not limited to microwave, infrared or other transmission techniques. The series of computer instructions whether contained in a tangible medium or not embodies all or part of the functionality previously described herein with respect to the invention. Those skilled in the art will appreciate that such computer instructions can be written in a number of programming languages for use with many computer architectures or operating systems and may exist in machine executable format. Further, such instructions may be stored using any memory technology, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, preloaded with a computer system, e.g., on system ROM or fixed disk, or distributed from a server or electronic bulletin board over a network, e.g., the Internet or World Wide Web.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. Further, the methods of the invention may be achieved in either all software implementations, using the appropriate processor instructions, or in hybrid implementations which utilize a combination of hardware logic and software logic to achieve the same results.

What is claimed is:

1. A computer program product for use with a computer system operatively connectable to a network and capable of capable of maintaining and displaying a virtual display of items associated with an auction, the computer program product comprising a computer readable medium having embodied therein program code comprising:
(A) program code for receiving selection indicia identifying one of the items associated with the auction, said item having a cost associated therewith;
(B) program code for calculating an index having a value less that the cost associated with the item; and
(C) program code, responsive to the index value, for identifying a first sponsorship level associated with the item; and
(D) program code for presenting the first sponsorship level.

2. The computer program product of claim 1 further comprising:
(E) program logic, responsive to the first sponsorship level, for identifying a second sponsorship level associated with the item.

3. The computer program product of claim 1 further comprising:
(F) program logic for displaying program logic for presenting the first sponsorship level.

4. A computer program product for use with a computer system operatively connectable to a network and capable of capable of maintaining and displaying a virtual catalog of items associated with an auction, the computer program product comprising a computer readable medium having embodied therein program code comprising:
(A) program code for maintaining an online accessible user-interface to a memory associated with data describing a plurality of consignable items;
(B) program code for defining at least one sponsorship level associated with a cost value of a consignable item;
(C) program code for receiving sponsor information identifying a sponsor and a donation value applicable to said cost of the consignable item;
(D) program code for determining if the value of the donation at least meets the sponsorship level; and
(E) program code for enabling display of one of the plurality of consignable items in conjunction with a link to a user interface for providing sponsor information.

5. The computer program product of claim 4 wherein the sponsor information comprises a sponsor identifier.

6. The computer program product of claim 4 wherein the sponsor information comprises a sponsor amount.

7. In a computer system operatively connectable to a network and capable of capable of maintaining data describing a plurality of items associated with an auction, a method comprising:
(A) displaying a plurality of consignable items associated with an auction;
(B) associating the plurality of consignable items with at least one of a plurality of sponsorship levels, each level having associated therewith a range of acceptable donation amounts; and
(C) providing a link to a user interface for providing one of sponsor information.

8. The method of claim 7 wherein the sponsor information comprises a sponsor identifier.

9. The method of claim 7 wherein the sponsor information comprises a sponsor amount.

10. The method of claim 7 wherein the sponsor information comprises sponsor payment data.

11. In a computer system operatively connectable to a network and capable of capable of maintaining and displaying a virtual catalog of items associated with an auction, an apparatus comprising:
(A) program logic for receiving selection indicia identifying one of the items associated with the auction, said item having a cost value associated therewith;
(B) program logic for calculating an index having a value less that the cost value associated with the item; and
(C) program logic, responsive to the index value, for identifying a first sponsorship level associated with the item; and
(D) program logic for presenting the first sponsorship level.

12. The apparatus of claim 11 further comprising:
(E) program logic, responsive to the first sponsorship level, for identifying a second sponsorship level associated with the item.

13. The apparatus of claim 12 further comprising:
(F) program logic for displaying program logic for presenting the first sponsorship level.

14. The apparatus of claim 11 wherein (B) further comprises:
(B1) program logic for at least partially deriving the index value from a value of cost associated with the item.

15. In a usable memory of a computer system capable of maintaining and displaying a virtual catalog of items associated with an auction, a data structure comprising:
(A) data identifying an item;
(B) data identifying a cost associated with the item; and
(C) data identifying a cumulative sponsorship value associated with the item.

16. The data structure of claim 15 further comprising:
(D) data identifying sponsor information.

17. The data structure of claim 16 further comprising:
(E) data identifying whether sponsorship of the item is closed.

18. A computer program product for use with a computer system operatively connectable to a network and capable of capable of maintaining and displaying a virtual catalog of items associated with an auction, the computer program product comprising a computer readable medium having embodied therein program code comprising:
(A) program code for receiving indicia identifying an item and a sponsorship amount, the item having a cost associated therewith;
(B) program code for calculating a total sponsorship amount for the identified item;
(C) program code for comparing total sponsorship amount with the cost of the item; and
(D) program code for closing sponsorship of the item if total sponsorship amount exceed the cost of the item.
